(19) United States
(12) Patent Application Publication
(10) Pub. No.: US 2026/0081754 A1
(43) Pub. Date: Mar. 19, 2026

(54) Adaptively Secure Attribute-Based Encryption Using Witness Encryption

(71) Applicant: NTT Research, Inc., Sunnyvale, CA (US)

(72) Inventors: Brent Waters, Austin, TX (US); Daniel Wichs, Boston, MA (US)

(73) Assignee: NTT Research, Inc., Sunnyvale, CA (US)

(21) Appl. No.: 19/329,193

(22) Filed: Sep. 15, 2025

Related U.S. Application Data
(60) Provisional application No. 63/694,865, filed on Sep. 15, 2024.

(51) Int. Cl. H04L 9/06; H04L 9/08; H04L 9/32

(52) U.S. Cl. CPC H04L 9/0618; H04L 9/0869; H04L 9/3221

(57) ABSTRACT

The present disclosure provides a method for secure message encryption and decryption using witness encryption. The method includes generating a master public key and a master secret key, generating common reference strings for a non-interactive zero-knowledge (NIZK) proof system and a commitment scheme, creating commitments using random values, and setting the master public and secret keys. A function key is generated by creating a dummy function tag and a NIZK proof. Message encryption involves generating a dummy input tag and creating a witness encryption ciphertext. The encrypted output includes attributes, the dummy input tag, and the witness encryption ciphertext. Decryption is performed using the function key and a witness decryption algorithm. The method enables secure message transmission with confidentiality and integrity throughout the encryption and decryption phases.

### CROSS-REFERENCE TO RELATED APPLICATION

This application claims the benefit of U.S. Provisional Application Ser. No. 63/694,865, filed Sep. 15, 2024, the content of which is incorporated by reference herein in its entirety, for all purposes.

### FIELD OF THE INVENTION

The present disclosure relates to cryptographic systems, and more particularly to an adaptively secure attribute-based encryption scheme constructed using witness encryption.

### BACKGROUND OF THE INVENTION

Attribute-based encryption (ABE) enables fine-grained control over which ciphertexts various users can decrypt. A master authority can create secret keys sk_{ƒ} with different functions (circuits) ƒ for different users. Anybody can encrypt a message under some attribute x so that only recipients with a key sk_{ƒ} for a function such that ƒ(x)=1 will be able to decrypt. There are a number of different approaches toward achieving selectively secure ABE, where the adversary has to decide on the challenge attribute x ahead of time before seeing any keys, including constructions via bilinear maps (for NC1 circuits), learning with errors, or witness encryption. However, when it comes adaptively secure ABE, the problem seems to be much more challenging and we only know of two potential approaches: via the “dual systems” methodology from bilinear maps, or via indistinguishability obfuscation.

Attribute-Based Encryption (ABE) is an advanced form of encryption where the user's ability to decrypt ciphertexts is governed by a policy attached to their key. In such a system a ciphertext encrypting a message m is associated with a attribute string x. A secret key in turn will be issued by some authority which associates it with some predicate function ƒ to generate sk_{ƒ}. Decryption semantics dictate that sk_{ƒ} will be able to decrypt a ciphertext associated with attribute x if ƒ(x)=1. A system is informally said to be secure if no attacker can distinguish between an encryption of message m₀ from m₁ under attribute x* so long as it only obtains secret keys for functions ƒ₁, . . . , ƒ_{q} where ƒᵢ(x*)=0. Over the past two decades ABE has emerged as an important construct for both encrypted access control as well as at tool for building other cryptographic primitives.

The first constructions of Attribute-Based Encryption utilized groups with efficiently computable bilinear maps and supported functions that could be expressed as boolean formulas or circuits of logarithmic depth in the security parameter. Several years later construction based on lattices emerged that were provably secure from the learning with errors (LWE) assumption. Remarkably, these construction supported policies that could be expressed as any circuit of a priori bounded depth and thus in principle of any function of fixed runtime. Around the same time a third avenue for realizing ABE systems manifested when Garg, Gentry, Sahai and Waters proposed the concept of witness encryption and showed how to build ABE from it. Witness is encryption is a powerful, yet general primitive where one encrypts a message m to a statement z and decryption is achievable for any decryptor which knows a witness w such that R(z, w)=1 for some family of relations indexed by the security parameter.

Proving security is a central and involved part of building ABE systems. All three (bilinear map, LWE and witness encryption) paths for realizing Attribute-Based Encryption first established solutions in the selective model of security where an attacker declares an attribute string x* before seeing either the public parameters of the system or receiving any private keys. This notion is meaningful; however, if fails to capture many “real life” attacks where an attacker might somehow influence the attribute string of a ciphertext in a way that depends on such information. While we can bridge the gap from selective to adaptive security using a complexity leveraging guessing strategy in conjunction with subexponential hardness assumptions, this is somewhat unsatisfactory both from the stronger assumption requirement and from an intellectual understanding standpoint.

Over the years achieving adaptive security has borne out to be quite challenging. Unlike Identity-Based Encryption (IBE) which admits a varied number of approaches, ABE systems must maintain the “structure” and semantics of the attribute string which rule out many hashing techniques. Going further it was formally shown that one cannot prove adaptive security using “paritioning” reductions which were integral to proving security for many IBE schemes. (A weaker notion called semi-adaptive security is known to be significantly easier to achieve, but appears to still be far from fully adaptive security.)

The first solutions for adaptively secure Attribute-Based Encryption applied the dual system encryption methodology of Waters using bilinear groups. In a dual system encryption proof, the challenge ciphertext is first changed to a semi-functional form. Following this each secret key issued will be changed one at a time to a semi-functional form which is inherently incompatible with the challenge ciphertext, but still compatible with all other normally generated ciphertexts. Unfortunately, to this point it has proven difficult to find adaptations of these ideas to either the LWE or witness encryption avenues described above. (One exception is the work of that gives an ABE system for a subset functionality which is more expressive than IBE string matching, but well short of ABE for boolean formulas or circuits.) From the learning with errors side, the algebraic analogs of bilinear map tools have not come fully to fruition. While witness encryption is a powerful primitive in some ways, it is arguably quite limited in others. In particular, it lacks the “hidden computation” aspect that is present in the more powerful concept of indistinguishability obfuscation. As such the only solutions for achieving adaptively secure ABE beyond bilinear maps have required indistinguishability obfuscation or functional encryption which precisely rely on such hidden computation properties.

### BRIEF SUMMARY OF THE INVENTION

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In this work, we give a new approach that constructs adaptively secure ABE from witness encryption (along with statistically sound NIZKs and one-way functions). While witness encryption is a strong assumption, it appears to be fundamentally weaker than indistinguishability obfuscation. Moreover, we have candidate constructions of witness encryption from some assumptions (e.g., evasive LWE) from which we do not know how to construct indistinguishability obfuscation, giving us adaptive ABE from these assumptions as a corollary of our work.

Results: Adaptive ABE from Witness Encryption. In this work, we construct adaptively secure attribute-based encryption from witness encryption along with statistically sound NIZKs and one-way functions. At a high level, we do so by showing how to employ dual system encryption techniques using witness encryption.

This is both an important and technically challenging endeavor. While we already had adaptive ABE from indistinguishability obfuscation (iO) have recently seen iO proven from “well founded” assumptions, witness encryption appears to be a fundamentally weaker primitive than iO. For example, we have black-box separations showing that witness encryption does not generically imply iO. Furthermore, witness encryption may admit solutions from a broader set of cryptographic assumptions. Two recent examples include the witness encryption built from variants of the evasive LWE assumption as well as a direction towards achieving witness encryption from pairing free groups. Therefore, we get adaptively secure ABE from (e.g.,) evasive LWE as a corollary of our work. Overall, we view the construction of advanced cryptosystems from plain witness encryption rather than iO as a well motivated and worthwhile endeavour.

Technically, witness encryption does not seem to support any form of hidden computation and thus appears to be incompatible with developing dual system encryption type proofs where we want to incrementally and undetectably change the form of the challenge ciphertext and private keys to make them mutually exclusive in a working decryption operation. We surmount this challenge by developing new tools and techniques for bringing in “outside” cryptography primitives to augment witness encryption to allow for such an argument.

According to aspects of the present disclosure, a method, system, and non-transitory computer-readable medium are provided for implementing an attribute-based encryption (ABE) scheme. The method comprises encrypting, by one or more processors of a computing device, a message μ for an attribute x by generating a dummy input tag tagₓ for the attribute x comprising a somewhere equivocal pseudorandom function key key and a garbled input \tilde{x} derived from x using cryptographic operations. The method creates a witness encryption ciphertext WE.ct by computationally encrypting μ using a witness encryption scheme WE.Enc implemented in software stored in a computer memory of the computing device, where the encryption is associated with a relation WE.R that includes computational verification of a NIZK proof π, a condition that ƒ(x)=1, and a condition that a function Trigger(tag_{ƒ}, tagₓ)=0. The Trigger function comprises computing a pseudorandom function on key and to t₀ derive a pad p, performing a bitwise XOR operation of p with t₁ to derive a garbled circuit \tilde{C}, and evaluating garbled circuit \tilde{C} on the garbled input \tilde{x} and outputting 1 if the result matches t₂. The method stores a ciphertext ct that includes x, tagₓ, and WE.ct in the computer memory of the computing device.

According to other aspects of the present disclosure, the method, system, and non-transitory computer-readable medium may include one or more of the following features. The method may further comprise generating, by the one or more processors, a master public key and a master secret key by generating a non-interactive zero-knowledge (NIZK) common reference string NIZK.crs using a cryptographically secure random number generator, generating a commitment scheme common reference string Com.crs using a cryptographically secure random number generator, generating first and second random values r₀ and r₁ from the set {0, 1}^{λ} using a cryptographically secure random number generator, creating a first commitment com₀ by computationally committing a zero value using the commitment scheme common reference string and the first random value r₀, creating a second commitment com₁ by computationally committing a string of zeros of length [symbol] (λ) using the commitment scheme common reference string and the second random value r₁, setting, in the computer memory, the master public key mpk to include Com.crs, NIZK.crs, com₀, and com₁, and setting, in the computer memory, the master secret key msk to be r₀.

The method may further comprise generating, by the one or more processors, a function key sk_{ƒ} for a function ƒ by generating a dummy function tag tag_{ƒ} for the function ƒ using a function tag system implemented in software, wherein the dummy function tag tag_{ƒ} comprises three random values t₀, t₁, t₂ from the set {0, 1}^{λ} generated using a cryptographically secure random number generator, creating the NIZK proof π using NIZK.crs, where the proof is computationally associated with an NP relation NIZK.R that includes a statement \tilde{x}=(Com.crs, com₀, com₁, ƒ, tag_{ƒ}) and a witness \tilde{w}=r₀, and storing the function key sk_{ƒ} as (ƒ, tag_{ƒ}, π) in the computer memory.

The method may further comprise decrypting, by the one or more processors, the ciphertext ct using a function key sk_{ƒ} by applying a witness decryption algorithm WE.Dec implemented in software to the witness encryption ciphertext WE.ct using (ƒ, tag_{ƒ}, π) as the witness, and storing the decrypted message μ in the computer memory.

The functional tag system may be configured for generating tagₓ←DInputTag(1^{λ}, x) and tag_{ƒ}←DFunctionTag(1^{λ}, ƒ). The garbled circuit may be a semi-adaptive blind circuit. The semi-adaptive blind garbled circuit scheme may further comprise an evaluation function Eval(\tilde{C}, \tilde{x}) that outputs the result of evaluating the garbled circuit \tilde{C} on the garbled input \tilde{x}. The functional tag system may include a trigger function Trigger(tag_{ƒ}, tagₓ) that outputs either 0 or 1 based on the input tag tagₓ and function tag tag_{ƒ}. The semi-adaptive blind garbled circuit scheme may satisfy a blindness property such that for any fixed garbling secret key sk and input x, the distribution of SimCircuit(sk, x, Uₘ) is identical to the uniform distribution over {0, 1} [symbol] , where SimCircuit is a simulated circuit generation function, Uₘ denotes the uniform distribution over m-bit strings, and [symbol] is the garbled circuit size. The method may achieve adaptive security for attribute-based encryption by utilizing the functional tag system in conjunction with the semi-adaptive blind garbled circuit scheme.

The method may be performed by distinct entities in communication with each other, comprising a key generation entity that generates the master public key and master secret key and transmits the master public key to other entities, a function key generation entity that receives the master public key and generates function keys, and an encryption entity that receives the master public key and performs the encryption operations. The witness encryption scheme WE.Enc may be selected from the group consisting of a multilinear maps-based construction that utilizes cryptographic multilinear maps, an indistinguishability obfuscation-based construction that obfuscates a program checking witness validity, a lattice-based construction utilizing the hardness of the Learning With Errors problem, and any arbitrary witness encryption scheme that may be interchangeably replaced with another witness encryption scheme.

The foregoing general description of the illustrative embodiments and the following detailed description thereof are merely exemplary aspects of the teachings of this disclosure and are not restrictive.

### BRIEF DESCRIPTION OF THE FIGURES

Non-limiting and non-exhaustive examples are described with reference to the following figures.

FIG. 1 illustrates a flowchart of a cryptographic process for attribute-based encryption, according to aspects of the present disclosure.

FIG. 2 depicts a flowchart of modules in a cryptographic process for attribute-based encryption, according to aspects of the present disclosure.

FIG. 3 illustrates a flowchart for a cryptographic method implementing witness encryption techniques, according to aspects of the present disclosure.

FIG. 4 illustrates a flowchart for a cryptographic process with trigger function evaluation, according to aspects of the present disclosure.

FIG. 5 illustrates a flowchart of a cryptographic method with NIZK proof verification, according to aspects of the present disclosure.

FIG. 6 illustrates a block diagram of a distributed ABE system architecture, according to aspects of the present disclosure.

FIG. 7 illustrates a functional tag system architecture with garbled circuit components, according to aspects of the present disclosure.

FIG. 8 illustrates a client computing architecture for implementing cryptographic operations, according to aspects of the present disclosure.

FIG. 9 illustrates a server-client network architecture for distributed cryptographic processing, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

A detailed description of systems, devices, and methods consistent with embodiments of the present disclosure is provided below. While several embodiments are described, it should be understood that disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The present disclosure relates to cryptographic systems and, more specifically, to an attribute-based encryption (ABE) scheme that leverages the power of witness encryption (WE). This innovative approach provides a robust and flexible framework for secure data encryption and decryption, offering potential advantages in terms of security, efficiency, and adaptability.

In the proposed ABE scheme, the ability to decrypt ciphertexts is governed by a policy attached to the user's key, allowing for fine-grained control over access to encrypted data. This is achieved by integrating the concept of witness encryption, a cryptographic primitive that ties decryption to the existence of a valid witness for a specific computational problem. The combination of ABE and WE in this manner enables the creation of an encryption scheme that is both powerful and versatile, capable of handling a wide range of computational problems and access policies.

A key feature of the disclosed ABE scheme is its adaptive security. Unlike many existing ABE schemes that only provide selective security, where the adversary must decide on the challenge attribute ahead of time, the proposed scheme offers adaptive security. This means that it remains secure even if the adversary can adaptively choose the challenge attribute based on previously seen keys. This level of security is achieved through the use of a functional tag system, a novel cryptographic tool that allows for the generation of input and function tags with specific triggering conditions.

The disclosed ABE scheme can be constructed using various types of witness encryption schemes, each with its own characteristics and security assumptions. This includes WE schemes based on multilinear maps, indistinguishability obfuscation (iO), lattice-based cryptography, and more. This flexibility allows the ABE scheme to leverage the strengths of different WE schemes and adapt to future advancements in cryptographic research.

The present disclosure provides an adaptively secure attribute-based encryption scheme that utilizes witness encryption, offering a powerful and flexible solution for secure data encryption and decryption. The integration of ABE and WE, along with the use of a functional tag system, results in an encryption scheme that is adaptable, versatile, and capable of providing robust security against adaptive adversaries.

### 1 Technical Overview

Selective ABE from WE. Some prior work constructed selectively secure ABE from witness encryption. The main idea behind their solution is to set the master public/secret key to be a the verification/signing key for a special type of signature scheme. The secret keys sk_{ƒ} are signature of the functions ƒ, and an encryption under an attribute x is a witness encryption that there exists some signature for some function ƒ such that ƒ(x)=1. In the proof of security, we can indistinguishably “constrain” the special signature scheme on the challenge attribute x* so that there only exist valid signatures π for functions ƒ for which ƒ(x*)=0. Then the security of witness encryption ensures that the message is hidden. The signature itself is implemented using statistically binding commitments and statistically sound NIZKs. Unfortunately, this proof strategy inherently only achieves selective security since we need to know the challenge attribute x* when creating the master public key of the ABE.

Overview of Our Approach. While our approach can also be seen relying on a special form of constrained signatures instantiated from commitments and NIZKs, the way we use these to achieve adaptive security is more sophisticated and is inspired by dual-system techniques. There are three main elements of our construction: (a) we introduce a new notion called a functional tag system, (b) we use a functional tag system to construct adaptive ABE from witness encryption (together with statistically binding commitments and statistically sound NIZKs), (c) we show how to construct a functional tag system from one-way functions. We now elaborate on each of these elements one by one.

Functional Tag System. A functional tag system allows us to generate “input tags” tagₓ for inputs x and “function tags” tag_{ƒ} for functions (i.e., circuits) ƒ. There is a dummy (D) way to generate such tags tagₓ←DInputTag(x), tag_{ƒ}←DFunctionTag(ƒ) randomly and independently of each other. There is also a smart (S) way to generate these using some common secret key tsk with tagₓ←SInputTag(tsk, x), tag_{ƒ}←SFunctionTag(tsk, ƒ). There is an efficient predicate Trigger(tag_{ƒ}, tagₓ) that checks if some pair of function/input tag “trigger”. Dummy pairs of tags trigger with only negligible probability. Smart pairs of tags generated using a common key tsk always trigger if ƒ(x)=1. A fully adaptive adversary who gets to see a single input tag tagₓ for an input x and many function tags tag_{ƒ}_{ᵢ} for functions ƒᵢ cannot tell the difference between seeing all dummy tags versus all smart tags generated using a common key tsk as long as ƒᵢ(x)=0 for all i.

ABE from WE via a Functional Tag System. We set the master public/secret key of the ABE to be the verification/signing key for a special type of “constrained” signature scheme, described later on. Each function secret key sk_{ƒ}=(ƒ, tag_{ƒ}, π) consists of a randomly generated “dummy function tag” tag_{ƒ}←DFunctionTag(ƒ) along with a signature π of the pair (ƒ, tag_{ƒ}). To encrypt a message under an attribute x, we generate a “dummy input tag” tagₓ←DInputTag(x) and send it along with a witness encryption of the message under the NP statement “there exists some pair (ƒ, tag_{ƒ}) that has a valid signature π such that ƒ(x)=1 and Trigger(tag_{ƒ}, tagₓ)=0”. (We note that, in contrast to prior selectively secure ABE schemes from LWE, our ABE is not succinct and the encryption run-time and ciphertext size scales with the circuit size of the supported functions ƒ.)

In the proof of security, we first switch to using “smart function tags” tag_{ƒ}←SFunctionTag(tsk, ƒ) in the secret keys sk_{ƒ} and a “smart input tag” tagₓ←SInputTag(tsk, x) in the challenge ciphertext, all generated using a common key tsk. By the adaptive security of the functional tag system, this is indistinguishable. We then indistinguishably “constrain” the special signature scheme so that valid signatures π only exist for pairs (ƒ, tag_{ƒ}) where tag_{ƒ}←SFunctionTag(tsk, ƒ). Finally, we argue that the NP statement used for the witness encryption is false, and therefore witness encryption security ensures that the encrypted message is hidden. This holds because whenever 7 is a valid signature of (ƒ, tag_{ƒ}) then it must be the case that tag_{ƒ}←SFunctionTag(tsk, ƒ), and if ƒ(x)=1, then it must also be the case that Trigger(tag_{ƒ}, tagₓ)=1.

The special constrained signature scheme is constructed from statistically binding commitments and statistically sound NIZKs as follows. The verification key consist of two commitments com₀, com₁ to 0, along with the CRS of the NIZK; the signing key is a decommitment of com₀. The signature π for a pair (ƒ, tag_{ƒ}) is a NIZK proof that “either com₀ is a commitment to 0 or com₁ is a commitment to tsk and there is some randomness r such that tag_{ƒ}=SFunctionTag(tsk, ƒ; r)”. The NIZK proof is generated using the decommitment of com₀ as the witness. To constrain the signature, we set com₀ to be a commitment to 1, com₁ to be a commitment to tsk and we generate the NIZKs using the decommitment to com₁ and the randomness used to generate tag_{ƒ} as the witness. The corresponding constrained verification key and signatures are indistinguishable.

Functional Tag System from One-Way Functions. Finally, we construct a functional tag system from one-way functions using “blind garbled circuits”. In blind garbled circuits, given an input x and a circuit C such that C(x) is uniformly random, the corresponding garbled input/circuit pair \tilde{x}, \tilde{C} look like uniformly random bits. We rely on a slightly more complex version of blind garbled circuits where the adversary can see many different garbled circuits \tilde{C}ᵢ but only one garbled input \tilde{x}; furthermore we allow semi-adaptive security where the circuits and the input can be chosen adaptively, but the challenge circuit must be chosen after the input. The detailed definition is somewhat cumbersome and we defer it to the main body, but we show that the basic “point and permute” construction of garbled circuits from one-way functions achieves this notion.

To construct a functional tag system from blind garbled circuits, we set dummy input tags tagₓ and dummy function tags tag_{ƒ} to be uniformly random values of appropriate size. To determine if a input/function tag pair (tag_{ƒ}, tagₓ) “triggers” we interpret tagₓ=\tilde{x} as a garbled input and tag_{ƒ}=(\tilde{C}, t) as a garbled circuit together with a target value t of length security parameter, and output 1 if the evaluation of the garbled circuit \tilde{C} on the garbled input \tilde{x} produces the target value t. In the dummy case, this only happens with negligible probability, ensuring “dummy correctness”. A smart input tag for x consists of a correctly garbled input tagₓ=\tilde{x}, and a smart function tag for ƒ consists of tag_{ƒ}=(\tilde{C}, t) where t is a random target value and \tilde{C} is a garbling of the circuit C that evaluates ƒ(x) and if the output is 1 it outputs the target value t else it outputs a random independent value u. This ensures that a smart input/function tag pair tagₓ, tag_{ƒ} does trigger when ƒ(x)=1.

For security, we intuitively want to rely on blind garbled circuits to ensure that we can replace dummy function tags with smart ones in the case where ƒ(x)=0, by relying on the fact that the circuit C(x) outputs a random independent value u in this case. However, there is an issue with adaptivity. Blind garbled circuits only provide semi-adaptive security, where the challenge circuit C must be chosen after the input x, while functional tag systems require fully adaptive security where the challenge functions ƒ can be chosen before or after the input x. We resolve this issue using techniques developed in the study of adaptively secure garbled circuits. In particular, we encrypt the garbled circuit with a “somewhere equivocal PRF” whose key is part of the input tag. For any circuit C chosen before the input x, this allows us to give a fake ciphertext inside tag_{ƒ} and only later equivocate the garbled circuit \tilde{C} inside the ciphertext after the input x is chosen, in affect allowing \tilde{C} to depend on x inside the security proof. Therefore, we can rely on semi-adaptive security of the blind garbled circuits to achieve fully adaptive security of the functional tag system.

### 2 Preliminaries

For any integer n≥1, define [n]={1 . . . , n}. A function v: [symbol] → [symbol] is said to be negligible, denoted v(n)=negl(n), if for every positive polynomial p(⋅) and all sufficiently large n it holds that v(n)<1/p(n). We use the abbreviation PPT for probabilistic polynomial time. For a finite set S, we write a←S to mean a is sampled uniformly randomly from S. For a randomized algorithm A, we let a←A(⋅) denote the process of running A(⋅) and assigning the outcome to a; when A is deterministic, we write a:=A(⋅) instead. For a randomized algorithm A we use the notation a:=A(⋅; r) to denote the process of running the randomized algorithm A with some fixed randomness r. We denote the security parameter by λ. For two distributions X, Y parameterized by λ we say that they are computationally indistinguishable, denoted by X≈_{c}Y if for every PPT distinguisher D we have |Pr[D(X)=1]−Pr[D(Y)=1]|=negl(λ).

### 2.1 Attribute Based Encryption (ABE)

We define an ABE scheme with adaptive security.

Definition 2.1 (Attribute-Based Encryption (ABE).). An ABE scheme a function class [symbol] _{λ}⊆{ƒ: {0, 1}^{n(λ)}→{0, 1}} consists of PPT procedures (Setup, KeyGen, Enc, Dec) with the following syntax:
(mpk, msk)←Setup(1^{λ}): Generates a master public key mpk and master secret key msk.
sk_{ƒ}←KeyGen(msk, ƒ): Generates a function key sk_{ƒ} for a function ƒ∈ [symbol] _{λ}.
ct←Enc(mpk, x, b): Given an attribute x∈{0,1}^{n(λ)} and a bit b∈{0,1} outputs a ciphertext ct.
b:=Dec(sk_{ƒ}, ct): Decrypts ct using sk_{ƒ}.

We require correctness and adaptive security defined as follows:
Correctness: There is some negligible function μ such that for all λ∈ [symbol] all ƒ∈ [symbol] _{λ} all x∈{0, 1}^{n(λ)} such that ƒ(x)=1 all b∈{0, 1} we have:

$$Pr [ \begin{matrix}Dec ( {sk}_{f} , ct ) & \begin{matrix}( mpk , msk ) ← Setup ( {1}^{λ} ) \\ {sk}_{f} ← KeyGen ( msk , f ) \\ ct ← Enc ( mpk , x , b )\end{matrix}\end{matrix} ] \leq μ ( λ ) .$$

Adaptive Security: We define the game ABE [symbol] (1^{λ}) between a challenger and an stateful adversary [symbol] (1^{λ}) as follows:
   The challenger chooses (mpk, msk)←Setup(1^{λ}) and gives mpk to [symbol] .
   Pre-challenge key queries: The adversary can make arbitrarily many queries ƒᵢ∈ [symbol] _{λ} and the challenger responds with sk_{ƒ}_{ᵢ}←KeyGen(msk, ƒᵢ).
   Challenge ciphertext: The adversary chooses an attribute x∈{0, 1}^{n(λ)} such that ƒᵢ(x)=0 for all pre-challenge key queries ƒᵢ, and the challenger responds with the challenge ciphertext ct←Enc(mpk, x, b).
   Post-challenge key queries: The adversary can make arbitrarily many additional queries ƒᵢ∈ [symbol] _{λ} such that ƒᵢ(x)=0 and the challenger responds with sk_{ƒ}_{ᵢ}←KeyGen(msk, ƒᵢ).
   The adversary output a bit b′ which is the output of the game.
We require that for all PPT [symbol] we have

$$\vert Pr [ ABE ( {1}^{λ} ) = 1 ] - Pr [ ABE ( {1}^{λ} ) = 1 ] \vert \leq ngel ( λ ) .$$

An ABE for circuits allows us to instantiate an ABE scheme for the function class

$${C}_{λ}^{s , n}$$

consisting of boolean circuits of size s(λ) with n(λ)-bit input, for any polynomials s(λ), n(λ).

### 2.2 Commitments

We define statistically binding commitments in the Common Reference String (CRS) model.

Definition 2.2 (Statistically Binding Commitments). A commitment scheme consists of PPT algorithms (Setup, Commit) with the following syntax:
crs←Setup(1^{λ}): generates a common reference string crs.
com:=Commit_{crs}(b; r): generates a commitment com to a bit b∈{0, 1} using randomness r∈{0, 1}^{λ}.

We require hiding and statistical binding:
Hiding: We have (crs, com₀)≈_{c}(crs, com₁) where crs←Setup(1^{λ}), com_{b}←Commit_{crs}(b).
Statistical Binding: We say that a crs is binding if there do not exist any r₀, r₁ such that Commit_{crs}(0; r₀)=Commit_{crs}(1; r₁). We require that: Pr[crs is binding: crs←Setup(1^{λ})]=1−negl(λ).

We abuse notation and write Commit_{crs}(x) for a string x∈{0, 1} [symbol] to denote the process of committing to each bit of x separately.

Naor's commitment scheme gives statistically binding commitments assuming only one-way functions. In particular, it constructs commitments from a pseudorandom generator PRG:{0, 1}^{λ}→{0, 1}^{3λ}, where Setup(1^{λ}) outputs a uniformly random crs←{0, 1}^{3λ} and Commit_{crs}(b; r)=PRG(r)⊕(b·crs). Hiding follows from PRG security and binding follows since

$${Pr}_{crs} [ ∃ {r}_{0} , {r}_{1} : PRG ( {r}_{0} ) = PRG ( {r}_{1} ) ⊕ crs ] \leq {\sum }_{{r}_{0} , {r}_{1}} Pr [ crs = PRG ( {r}_{0} ) ⊕ PRG ( {r}_{1} ) ] \leq {2}^{2 λ} / {2}^{3 λ} \leq {2}^{- λ} .$$

Theorem 2.3. Assuming one-way functions, there exist statistically binding commitments.

### 2.3 NIZKs

We define statistically sound NIZKs in the CRS model with witness indistinguishability.

Definition 2.4 (Statistically Sound Non-Interactive Zero-Knowledge (NIZK)). A NIZK proof system for an NP relation R_{λ}⊆{0, 1}^{n(λ)}×{0, 1}^{m(λ)} with a corresponding NP language L_{λ}={x: ∃w (x, w)∈R_{λ}} consists of PPT algorithms (Setup, Prove, Verify) with the following syntax:
crs←Setup(1^{λ}): generates a common reference string crs.
π←Prove_{crs}(x, w): generates a proof π for the statement x using witness w.
b=Verify_{crs}(x, π): verifies the proof π for a given statement x and outputs a decision bit 0 (reject) or 1 (accept).

We require the following properties:
Completeness: There exists a negligible function μ such that for all λ∈ [symbol] , all (x, w)∈R_{λ} we have:

$$Pr [ {Verify}_{crs} ( x , π ) = 1 : crs ← Setup ( {1}^{λ} ) , π ← {Prove}_{crs} ( x , ω ) ] \geq 1 - μ ( λ ) .$$

Statistical Soundness: We say that a crs is sound if for all x∉L_{λ} and all π we have Verify_{crs}(x, π)=0. We require that Pr[crs is sound: crs←Setup(1^{λ})]=1−negl(λ).
Witness Indistinguishability: For any ensemble x_{λ},

$${ω}_{λ}^{0} , {ω}_{λ}^{1}$$

such that

$$( {x}_{λ} , {ω}_{λ}^{b} )$$

∈R_{λ} for b∈{0, 1} we have (crs, π₀)≈_{c}(crs, π₁) where crs←Setup(1^{λ}) and π_{b}←Prove_{crs}

$$( {x}_{λ} , {ω}_{λ}^{b} )$$

for b∈{0, 1}.

A NIZKs for NP allows us to instantiate NIZK for any polynomial-time NP relation R_{λ}. We remark that the property of witness indistinguishability is weaker than an implied by the zero knowledge property typically associated with NIZKs.

Theorem 2.5. Statistically sound NIZKs in the CRS model exist assuming any one of (1) hardness of factoring, or (2) the decisional linear assumption in bilinear groups, or (3) the learning with errors assumption.

### 2.4 Witness Encryption

We define a witness encryption scheme.

Definition 2.6 (Witness Encryption). A witness encryption scheme for an NP relation R_{λ}⊆{0, 1}^{n(λ)}×{0, 1}^{m(λ)} with a corresponding NP language L_{λ}={x: ∃w (x, w)∈R_{λ}} consists of PPT algorithms (Enc, Dec) with the following syntax:
ct←Enc(1^{λ}, x, b): Encrypts a bit b∈{0, 1} under the NP statement x∈{0, 1}^{n(λ)}.
b=Dec(ct, w): Decrypts the ciphertexts using a witness w.

We require the following properties:
Correctness: There exists a negligible function μ such that for all λ∈ [symbol] , all (x, w)∈R_{λ} we have:

$$Pr [ Dec ( Enc ( {1}^{λ} , x , b ) , ω ) = b ] \geq 1 - μ ( λ ) .$$

Security: For any ensemble {x_{λ}} [symbol] such that x_{λ}∉L_{λ} for all λ, we have

$$Enc ( {1}^{λ} , {x}_{λ} , 0 ) {\approx }_{c} Enc ( {1}^{λ} , {x}_{λ} , 1 ) .$$

A WE for NP allows us to instantiate WE for any polynomial-time NP relation R_{λ}.

We abuse notation and write Enc(1^{λ}, x, m) for a long message m∈{0, 1} [symbol] to denote the process of encrypting the message bit-wise Enc(1^{λ}, x, m₁), . . . , Enc(1^{λ}, x, [symbol] ).

### 2.5 Somewhere Equivocal PRF

We define the notion of a somewhere equivocal PRF (SEPRF). Intuitively, an SEPRF consists of a pseudorandom function y=PRF(key, x) that maps inputs x to outputs y using a secret key. For any input x*, there is a way to generate an equivocal key eqKey that leaves the output of the PRF unspecified at x*, but allows us to evaluate it at all input x≠x* by computing PRF(eqKey, x). Later for any output y* we can fix the output of the PRF at x* to y* by generating a key key such that PRF(key, x*)=y*, while ensuring PRF(key, x)=PRF(eqKey, x) for all x≠x*. Moreover, for any x*, one cannot distinguish between an honestly generated key versus first generating eqKey that is equivocal at x* and later fixing the output of the PRF at x* to a uniformly random y* by generating the corresponding key.

Definition 2.7 (SEPRF). An SEPRF with input length n(λ) and output length m(λ) consists of the PPT algorithms (KeyGen, PRF, Sim₁, Sim₂) with the following syntax:
key←KeyGen(1^{λ}): generates a PRF key.
y=PRF(key, x): A deterministic algorithm that takes as input x∈{0, 1}^{n(λ)} and outputs y∈{0, 1}^{m(λ)}.
eqKey←Sim₁(1^{λ}, x*): Given x*∈{0, 1}^{n(λ)} outputs a key eqKey that is equivocal on x*.
key←Sim₂(eqKey, y*): Given an output y*∈{0, 1}^{m(λ)} creates an equivocated key key.

We require two properties:
Correctness: For all x*∈{0, 1}^{n(λ)}, y*∈{0, 1}^{m(λ)} we have

$$Pr [ \begin{matrix}PRF ( key , {x}^{*} ) = {y}^{*} & eqKey ← {Sim}_{1} ( {1}^{λ} , {x}^{*} ) \\ ∧ ∀ x \neq {x}^{*} : PRF ( key , x ) = PRF ( eqKey , x ) : & key ← {Sim}_{2} ( eqKey , {y}^{*} )\end{matrix} ] = 1.$$

Security: We define the game SEPRF [symbol] (1^{λ}) between a challenger and an stateful adversary [symbol] (1^{λ}) as follows:
   The adversary chooses x*∈{0, 1}^{n(λ)}.
   If b=0 the challenger chooses key←KeyGen(1^{λ}) and gives key to the adversary.
   If b=1 the challenger chooses eqKey←Sim₁(1^{λ}, x*), y*←{0,1}^{m(λ)}, key←Sim₂(eqKey, y*) and gives key to the adversary.
   The adversary outputs a bit b′ which is the output of the game.
We require that for all PPT A we have

$$\vert Pr [ SEPRF ( {1}^{λ} ) = 1 ] - Pr [ SEPRF ( {1}^{λ} ) = 1 \vert \leq negl ( λ ) .$$

Theorem 2.8. Assuming the existence of one-way functions, for any polynomials n=n(λ), m=m(λ) there exists an SEPRF with input length n and output length m.

### 3 Functional Tag System

Our paper consists of three main components: (1) introducing a new notion of functional tag systems in this section, (2) constructing a functional tag system from one-way functions via garbled circuits in Section 4, and (3) constructing adaptively secure ABE from WE via a functional tag system in Section 5.

A functional tag system allows us to generate “input tags” tagₓ for inputs x and “function tags” tag_{ƒ} for functions ƒ. There is a dummy (D) way to generate these randomly/independently and a smart (S) way to generate these in a coordinated way using some common secret key tsk. There is an efficient procedure that checks if some combinations of (tag_{ƒ}, tagₓ) “trigger”. Dummy ones trigger with negligible probability. Smart ones always trigger if ƒ(x)=1. A fully adaptive adversary who gets to see a single input tag for an input x and many function tags for functions ƒᵢ cannot tell the difference between dummy and smart as long as ƒᵢ(x)=0 for all i.

Definition 3.1 (Functional Tag System). A functional tag system for a function class [symbol] _{λ}⊆{ƒ: {0, 1}^{n(λ)}→{0, 1}} consists of PPT procedures
(DInputTag, DFunctionTag, SGen, SInputTag, SFunctionTag, Trigger)
   with the following syntax:
tagₓ←DInputTag(1^{λ}, x) takes as input x∈{0,1}^{n(λ)} and generates a “dummy input tag”.
tag_{ƒ}←DFunctionTag(1^{λ}, ƒ) takes as input ƒ∈ [symbol] _{λ} and generates a “dummy function tag”.
tsk←SGen(1^{λ}) generates a tag key tsk.
tagₓ←SInputTag(tsk, x) takes as input x∈{0, 1}^{n(λ)} and generates a “smart input tag”.
tag_{ƒ}←SFunctionTag(tsk, ƒ) takes as input ƒ∈ [symbol] _{λ} and generates a “smart function tag”.
b=Trigger(tag_{ƒ}, tagₓ) a deterministic procedure that outputs 0 (not triggered) or 1 (triggered).

The scheme has the following properties:
1. Dummy Correctness: There exists some negligible μ such that for all λ∈ [symbol] , ƒ∈ [symbol] _{Δ}, x∈{0, 1}^{n(λ)}:

$$Pr [ Trigger ( {tag}_{f} , {tag}_{x} ) = 1 : \begin{matrix}{tag}_{x} ← DInputTag ( x ) \\ {tag}_{f} ← DFunctionTag ( f )\end{matrix} ] \leq μ ( λ ) .$$

2. Smart Correctness: For all λ∈ [symbol] , ƒ∈ [symbol] _{Δ}, x∈{0, 1}^{n(Δ)} such that ƒ(x)=1:

$$Pr [ Trigger ( {tag}_{f} , {tag}_{x} ) = 1 : \begin{matrix}tsk ← SGen ( {1}^{λ} ) \\ {tag}_{x} ← SInputTag ( tsk , x ) \\ {tag}_{f} ← SFunctionTag ( tsk , f )\end{matrix} ] = 1.$$

3. Security: We define the game FunTag [symbol] (1^{λ}) between a challenger with a bit b and an stateful adversary [symbol] (1^{λ}) as follows:
   If b=1, the challenger samples a random tsk←SGen(1^{λ}).
   Pre-challenge function tag queries: The adversary can make arbitrarily many queries ƒᵢ∈ [symbol] _{Δ}. If b=0 the challenger responds with tag_{ƒ}_{ᵢ}←DFunctionTag(1^{λ}, ƒᵢ) and if b=1 the challenger responds with tag_{ƒ}_{ᵢ}←SFunctionTag(tsk, ƒᵢ).
   Challenge input tag: The adversary chooses an input x∈{0, 1}^{n(λ)} such that ƒᵢ(x)=0 for all prior function tag queries ƒᵢ. If b=0 the challenger responds with tagₓ←DInputTag(1^{λ}, x) and if b=1 the challenger responds with tagₓ←SInputTag(tsk, x).
   Post-challenge function tag queries: The adversary can make arbitrarily many additional queries ƒᵢ∈ [symbol] _{λ} such that ƒᵢ(x)=0. If b=0 the challenger responds with tag_{ƒ}_{ᵢ}←DFunctionTag(1^{λ}, ƒᵢ) and if b=1 the challenger responds with tag_{ƒ}_{ᵢ}←SFunctionTag(tsk, ƒᵢ).
   The adversary output a bit b′ which is the output of the game.

We require that for all PPT [symbol] we have

$$\vert Pr [ FunTag ( {1}^{λ} ) = 1 ] - Pr [ FunTag ( {1}^{λ} ) = 1 ] \vert \leq negl ( λ ) .$$

A functional tag system for circuits allows us to instantiate a functional tag system for the class

$${C}_{λ}^{s , n}$$

consisting of boolean circuits of size s(λ) with n(λ)-bit input, for any polynomials s(λ), n(λ).
4 A Functional Tag System from One-Way Functions

We construct a functional tag system for circuits from one-way functions. Our main tool is a special form of blind garbled circuits. We first define and construct this form of blind garbled circuits and then proceed to use them to construct a functional tag system.

### 4.1 Blind Garbled Circuits

We rely on blind garbled circuits. In a blind garbled circuits, if one gets a garbled input together with a garbled circuit that outputs a uniformly random value on that input, the pair looks like completely random bits. We rely on a variant of blind garbled circuit security that we call semi-adaptive blind garbled circuits, defined formally below. Informally, we consider a game where the adversary can get arbitrarily many garbled circuits and a single garbled input \tilde{x} of a value x, all chosen adaptively. In addition the adversary chooses a challenge circuit C after it gets the garbled input \tilde{x} and should not be able to distinguish between a real garbling \tilde{C} of the challenge circuit C versus a simulated one. Note that the input x cannot depend on the garbled circuit \tilde{C}, which avoids the main difficulty in adaptively secure garbled circuits. The simulator needs to simulate the garbled circuit \tilde{C} given x, C(x), but without knowing the circuit C. For blindness, we require that, for a uniformly random output C(x), the corresponding simulated garbled circuit \tilde{C} is uniformly random.

Definition 4.1 (Semi-adaptive Blind Garbled Circuit). Let

$${C}_{λ}^{s , n , m}$$

be a class of circuits of size s=s(λ) with n=n(λ)-bit input and m=m(λ)-bit output. A semi-adaptive blind garbled circuit scheme for

$${𝒞}_{λ}^{s , n , m}$$

consist of PPT algorithms: (GarbleGen, GInput, GCircuit, SimCircuit, Eval) and garbled circuit size parameter [symbol] = [symbol] (λ) with the following syntax.
sk←GarbleGen(1^{λ}): generates a garbling secret key sk.
\tilde{x}←GInput(sk, x): garbles an input x∈{0, 1}ⁿ.
\tilde{C}←GCircuit(sk, C): garbles a circuit C∈

$${𝒞}_{λ}^{s , n , m}$$

with C∈{0, 1} [symbol] .
y:=Eval(\tilde{C}, \tilde{x}): a deterministic algorithm that evaluates the garbled circuit on the garbled input and yields output y∈{0, 1}^{m}.
\tilde{C}←SimCircuit(sk, x, y): produces a simulated circuit \tilde{C}∈{0, 1} [symbol] for a given output y=C(x) without knowing C.

We require the following properties:
Correctness: For all λ, C∈

$${𝒞}_{λ}^{s , n , m}$$

x∈{0, 1}ⁿ we have

$$Pr [ Eval ( \tilde{C} , \tilde{x} ) = C ( x ) : sk ← GarbleGen ( {1}^{λ} ) , \tilde{x} ← Glnput ( sk , x ) , \tilde{C} ← GCircuit ( sk , C ) ] = 1.$$

Semi-Adaptive Simulation Security: We define the game GC [symbol] (1^{λ}) between a challenger with a bit b and stateful adversary [symbol] (1^{λ}) as follows:
   Challenger picks sk←GarbleGen(1^{λ}).
   Adversary [symbol] ^{GCircuit(sk,⋅)} picks x∈{0, 1}ⁿ and gets back \tilde{x}←GInput(sk, x).
   Adversary [symbol] ^{Gcircuit(sk,⋅)} picks a boolean circuit C∈

$${𝒞}_{λ}^{n , m} .$$

The adversary gets back either \tilde{C}←GCircuit(sk, C) if b=0 or \tilde{C}←SimCircuit(sk, x, C(x)) if b=1.
Adversary [symbol] ^{Gcircuit(sk,⋅)} outputs a bit b′ which is the output of the game.

We require that for all PPT [symbol] we have

$$\vert Pr [ GC ( {1}^{λ} ) = 1 ] - Pr [ GC ( {1}^{λ} ) = 1 ] \vert \leq negl ( λ ) .$$

Blindness: For every fixed choice of sk in the support of GarbleGen(1^{λ}) every x∈{0, 1}ⁿ we have:

$$SimCircuit ( sk , x , {U}_{m} ) ≡ {U}_{ℓ} ,$$

where Uᵢ denotes the uniform distribution over {0, 1}ⁱ and “≡” denotes distributional equivalence.

Construction. Let s(λ), n(λ), m(λ) be arbitrary polynomials. We assume that circuits in

$${𝒞}_{λ}^{s , n , m}$$

have some fixed topology. In particular, each circuit C∈

$${𝒞}_{λ}^{s , n , m}$$

consists of s gates and s+n+m wires, with n input wires denoted in₁, . . . inₙ, m output wires denoted out₁, . . . , outₘ and s internal wires. Each gate g∈[s] gets 2 input wires and 1 output wire; we allow arbitrary fan-out since each output wire can be an input to arbitrarily many other gates. Each gate g computes some function ƒ_{g}: {0, 1}²→{0, 1}. The gates are connected via some fixed topology that is the same for all circuits in the class: that is, any gate g∈[s] has some fixed input writes w_{g,1}, w_{g,2} and output wire w_{g,w} for all C∈

$${𝒞}_{λ}^{s , n , m} .$$

The only distinction between different circuits C∈

$${𝒞}_{λ}^{s , n , m}$$

are the functions ƒ_{g} computed by each gate. Note that we can convert general circuits into ones having a fixed topology with only a polylogarithmic blowup in circuit size via universal circuits, and therefore the above assumption is without loss of generality. Let PRF: {0, 1}^{λ}×{0, 1}*→{0, 1}^{λ+1} be a pseudorandom function. The “point-and-permute” construction of blind garbled circuits for the class

$${𝒞}_{λ}^{s , n , m}$$

work as follows:
sk←GarbleGen(1^{λ}): For each of the n input wires inᵢ, sample PRF keys sᵢₙ_{ᵢ}_{,b}←{0, 1}^{λ} and random bits αᵢₙ_{ᵢ}←{0, 1} for i∈[n], b∈{0, 1}. Let sk=(sᵢₙ_{ᵢ}_{,b}, αᵢₙ_{ᵢ})_{i∈[n],b∈{0,1}}.
\tilde{x}←GInput(sk, x): For x=(x₁, . . . , xₙ)∈{0, 1}ⁿ output y=(sᵢₙ_{ᵢ}_{,x}_{ᵢ}, αᵢₙ_{ᵢ}⊕xᵢ)_{i∈[n]}.
\tilde{C}←GCircuit(sk, C): Sample a random circuit nonce c←{0, 1}^{λ}. For each wire w that is not an input wire sample fresh PRF keys s_{w,b}←{0, 1}^{λ} for b∈{0, 1} along with a random bit α_{w}←{0, 1}. The corresponding values sᵢₙ_{ᵢ}_{,b}, αᵢₙ_{ᵢ} for the input wires inᵢ are contained in sk. For each gate g, let ƒ_{g}: {0, 1}²→{0, 1} be the Boolean function computed by the gate. For every gate g∈[s] with input wires w₁, w₂ and output wire w₃, and for all β₁, β₂∈{0, 1}, set β₃:=ƒ_{g}(α_{w}_{₁}⊕β₁, α_{w}_{₂}⊕β₂)⊕α_{w}_{₃}, and compute the table entry:

$${T}_{g}^{{β}_{1} , {β}_{2}} := ( {s}_{{w}_{3} , {α}_{{w}_{3}} ⊕ {β}_{3}} ‖ {β}_{3} ) ⊕ PRF ( {s}_{{w}_{1} , {α}_{{w}_{1}} ⊕ {β}_{1}} , c \vert \vert g \vert \vert {β}_{1} \vert \vert {β}_{2} ) ⊕ PRF ( {s}_{{w}_{2} , {α}_{{w}_{2}} ⊕ {β}_{2}} , c \vert \vert g \vert \vert {β}_{1} \vert \vert {β}_{2} ) . \qquad ( 1 )$$

Define the table for gate g as

$${T}_{g} := {( {T}_{g}^{{β}_{1} , {β}_{2}} )}_{{β}_{1} , {β}_{2} ∈ \{ 0 , 1 \}} .$$

Then, output the garbled circuit consisting of:

$$\tilde{C} = ( c , {( {T}_{g} )}_{g ∈ [ s ]} , {( {α}_{{out}_{j}} )}_{j ∈ [ m ]} ) , \\ with \tilde{C} ∈ {\{ 0 , 1 \}}^{ℓ} for ℓ = λ + 4 ( λ + 1 ) s + m .$$

y:=Eval(\tilde{C}, \tilde{x}): Parse \tilde{x}=(sᵢₙ_{ᵢ}, βᵢₙ_{ᵢ})_{i∈[n]}. For every gate g∈[s] in topological order, let w₁, w₂ be its input wires and let w₃ be its output wire. Then, given (s_{w}_{₁}∥β_{w}_{₁}), (s_{w}_{₂}∥β_{w}_{₂}), compute

$$( {s}_{{w}_{3}} ‖ {β}_{{w}_{3}} ) = {T}_{g}^{{β}_{{w}_{1}} , {β}_{{w}_{2}}} ⊕ PRF ( {s}_{{w}_{1}} , c ‖ g ‖ {β}_{{w}_{1}} ‖ {β}_{{w}_{2}} ) ⊕ PRF ( {s}_{{w}_{2}} , c ‖ g ‖ {β}_{{w}_{1}} ‖ {β}_{{w}_{2}} ) .$$

Finally, upon obtaining βₒᵤₜ_{ⱼ}, set yⱼ:=βₒᵤₜ_{ⱼ}⊕αₒᵤₜ_{ⱼ} for j∈[m] and output y:=(y₁, . . . , yₘ)∈{0, 1}^{m}.
\tilde{C}←SimCircuit(sk, x, y): Sample a random circuit nonce c←{0, 1}^{λ}. For each wire w that is not an input wire sample a fresh PRF key s_{w}←{0, 1}^{λ} along with a random bit β_{w}←{0, 1}. For each input wire inᵢ, set sᵢₙ_{ᵢ}:=sᵢₙ_{ᵢ}_{,x}_{ᵢ} βᵢₙ_{ᵢ}:=xᵢ⊕αᵢₙ_{ᵢ} using the values from sk. For each gate g with input wires w₁, w₂ and output wire w₃, compute

$${T}_{g}^{{β}_{{w}_{1}} , {β}_{{w}_{2}}} := ( {s}_{{w}_{3}} ‖ {β}_{{w}_{3}} ) ⊕ PRF ( {s}_{{w}_{1}} , c ‖ g ‖ {β}_{{w}_{1}} ‖ {β}_{{w}_{2}} ) ⊕ PRF ( {s}_{{w}_{2}} , c ‖ g ‖ {β}_{{w}_{1}} ‖ {β}_{{w}_{2}} ) , \qquad ( 2 )$$

and choose

$${T}_{g}^{{β}_{0} , {β}_{1}}$$

←{0, 1}^{λ+1} uniformly at random for all (β₀, β₁)≠(β_{w}_{₁}, β_{w}_{₂}). Define the table for gate g as

$${T}_{g} := {( {T}_{g}^{{β}_{1} , {β}_{2}} )}_{{β}_{1} , {β}_{2} ∈ \{ 0 , 1 \}} .$$

Output

$$\tilde{C} = ( c , {( {T}_{g} )}_{g ∈ [ s ]} , {( {β}_{{out}_{j}} ⊕ {y}_{j} )}_{j ∈ [ m ]} ) .$$

Theorem 4.2. Assuming one-way functions, there exist semi-adaptive blind garbled circuits for the class

$${C}_{λ}^{s , n , m}$$

for any polynomials s, n, m.
4.2 Functional Tag System from Blind Garbled Circuits

We construct a functional tag system (Def. 3.1) from one-way functions using blind garbled circuits (Def. 4.1) and a somewhere equivocal PRF (Def. 2.7). As a starting point of our construction, we set dummy input tags to be garbled inputs tagₓ=\tilde{x} using a fresh garbling key sk, and dummy function tags tag_{ƒ}=(\tilde{C}, t) consist of a uniformly random garbled circuit \tilde{C}←{0, 1} [symbol] along with some target value t. An input/function tag “triggers” if evaluating the garble circuit \tilde{C} on the garbled input \tilde{x} produces the target value t. In the dummy case, this only happens with negligible probability, ensuring “dummy correctness”. A smart input tag is a garbled inputs tagₓ=\tilde{x} using a garbling key sk contained in the tag key tsk=sk, and a smart function tag tag_{ƒ}=(\tilde{C}, t) consists of a random target value t along with a correctly garbled circuit \tilde{C}←GCircuit(tsk, C) of the circuit C that evaluates ƒ(x) and if the output is 1 it outputs the target value t else it outputs a random independent value u. This ensures that a smart input/function tag pair tagₓ, tag_{ƒ} does trigger when ƒ(x)=1. For security, we intuitively want to rely on blind garbled circuits to ensure that we can replace dummy function tags with smart ones in the case where ƒ(x)=0, by relying on the fact that the circuit C(x) outputs a random independent value u in this case. However, there is an issue with adaptivity. Blind garbled circuits only provide semi-adaptive security, where the challenge circuit C must be chosen after the input x, while functional tag systems require fully adaptive security where the challenge functions ƒ can be chosen before or after the input x. We resolve this issue by encrypting the garbled circuit with a somewhere equivocal PRF whose key is part of the input tag. For any circuit C chosen before the input x, this allows us to give a fake ciphertext inside tag_{ƒ} and only later equivocate the garbled circuit \tilde{C} inside the ciphertext after the input x is chosen, in affect allowing \tilde{C} to depend on x inside the security proof. Therefore, we can rely on semi-adaptive security of the blind garbled circuits to achieve fully adaptive security of the functional tag system.

Construction. Let n=n(λ), s=s(λ) be any polynomials. We construct a functional tag system for the class [symbol] _{λ}=

$${C}_{λ}^{s , n}$$

consisting of circuits of size s with n-bit input and 1-bit output. Let (GarbleGen, GInput, GCircuit, Eval) be a semi-adaptive blind garbled circuit for the class

$${C}_{λ}^{{s}^{′} , n , m = sec} ,$$

where s′=s+O(λ) will be defined later, and let [symbol] = [symbol] (λ) be the corresponding garbled circuit size. Let (KeyGen, PRF, Sim₁, Sim₂) be a somewhere equivocal PRF with input length λ and output length [symbol] . We construct a functional tag system (DInputTag, DFunctionTag, SGen, SInputTag, SFunctionTag, Trigger) defined as follows:
tagₓ←DInputTag(x): Choose sk←GarbleGen(1^{λ}), key←KeyGen(1^{λ}), \tilde{x}←GInput(sk, x). Output tagₓ=(key, \tilde{x}).
tag_{ƒ}←DFunctionTag(ƒ): Output tag_{ƒ}=(t₀, t₁, t₂)←{0, 1}^{λ}×{0, 1} [symbol] ×{0, 1}^{λ}.
tsk←SGen(1^{λ}): Choose sk←GarbleGen(1^{λ}), key←KeyGen(1^{λ}) and set tsk=(sk, key).
tagₓ←SInputTag(tsk, x): Choose \tilde{x}←GInput(sk, x). Output tagₓ=(key, \tilde{x}).
tag_{ƒ}←SFunctionTag(tsk, ƒ): Choose t₀, t₂, u←{0, 1}^{λ} and let

$${C}_{f , u , {t}_{2}}^{*}$$

be the circuit that on input x outputs u if ƒ(x)=0 and outputs t₂ if ƒ(x)=1. We define the parameter s′=s+O(λ) be the size of

$${C}_{f , u , {t}_{2}}^{*}$$

for ƒ∈ [symbol] ^{s,n}. Let \tilde{C}←GCircuit(sk,

$${C}_{f , u , {t}_{2}}^{*}$$

and set t₁=PRF(key, t₀)⊕\tilde{C}. The output is tag_{ƒ}=(t₀, t₁, t₂).
Trigger(tag_{ƒ}, tagₓ): Parse tagₓ=(key, \tilde{x}), tag_{ƒ}=(t₀, t₁, t₂). Let \tilde{C}:=PRF(key, t₀)⊕t₁. Output 1 iff Eval(\tilde{C}, \tilde{x})=t₂.

Theorem 4.3. Assuming one-way functions, for any polynomials n=n(λ), s=s(λ), there exists a functional tag system for the class [symbol] _{λ}=

$${C}_{λ}^{s , n} .$$

5 Adaptive ABE from WE Via a Functional Tag System

We construct an adaptively secure ABE scheme for circuits using:
a statistically binding commitment scheme (Com.Setup, Commit) per Definition 2.2,
a statistically sound witness indistinguishable NIZK for NP (NIZK.Setup, Prove, Verify) per Definition 2.4,
a witness encryption scheme for NP (WE.Enc, WE.Dec) per Definition 2.6,
a functional tag system for circuits (DInputTag, DFunctionTag, SGen, SInputTag, SFunctionTag, Trigger) per Definition 3.1 where the tag key tsk←SGen(1^{λ}) is of length |tsk|= [symbol] (λ).

For any polynomials s(λ), n(λ), let us fix the function class

$${C}_{λ}^{s , n}$$

to consist of boolean circuits of size s(λ) with n(λ)-bit input. We construct an ABE for the function class

$${C}_{λ}^{s , n}$$

using a functional tag system for

$${C}_{λ}^{s , n}$$

as a building block. We specify the NP relations NIZK.R, WE.R for the NIZK and WE inside the construction.

Construction. The ABE scheme (Setup, KeyGen, Enc, Dec) is defined as follows:
(msk, mpk)←Setup(1^{λ}): Choose NIZK.crs←NIZK.Setup(1^{λ}), Com.crs←Com.Setup(1^{λ}), r₀, r₁←{0, 1}^{λ}, and set

com₀:=Commit_{Com.crs}(0;r₀), com₁:=Commit_{Com.crs}(0^{l(λ)};r₁).
Output mpk:=(Com.crs, NIZK.crs, com₀, com₁), msk:=r₀.
sk_{ƒ}←KeyGen(msk, ƒ): Generate tag_{ƒ}←DFunctionTag(1^{λ}, ƒ). Give a NIZK proof

π←Prove_{NIZK.crs}(\tilde{x}=(Com.crs,com₀,com₁,ƒ,tag_{ƒ}),\tilde{w}=r₀)
for the NP relation

$$NIZK . R = \{ \begin{matrix}\tilde{x} = ( Com . crs , {com}_{0} , {com}_{1} , f , {tag}_{f} ) \\ ( \tilde{x} , \tilde{w} ) : \begin{matrix}either \tilde{w} = {r}_{0} & : & {com}_{0} = {Commit}_{Com . crs} ( 0 ; {r}_{0} ) \\ or \tilde{w} = ( tsk , {r}_{1} , {r}_{2} ) & : & {com}_{1} = {Commit}_{Com . crs} ( tsk ; {r}_{1} ) \\ & & ∧ {tag}_{f} = SFunctionTag ( tsk , f ; {r}_{2} )\end{matrix}\end{matrix} \} .$$

Output sk_{ƒ}=(ƒ, tag_{ƒ}, π)
ct←Enc(mpk, x, μ): Generate tagₓ←DInputTag(1^{λ}, x) and a witness encryption WE.ct←WE.Enc(1^{λ}, \hat{x}=(Com.crs, NIZK.crs, x, com₀, com₁, tagₓ), μ) for the relation

$$WE . R = \{ ( \hat{x} , \hat{w} ) : \begin{matrix}\hat{x} = ( Com . crs , NIZK . crs , {com}_{0} , {com}_{1} , x , {tag}_{x} ) , \hat{w} = ( f , {tag}_{f} , π ) \\ {Verify}_{NIZK . crs} ( \tilde{x} = Com . crs , {com}_{0} , {com}_{1} , f , {tag}_{f} ) , π ) = 1 \\ ∧ f ( x ) = 1 ∧ Trigger ( {tag}_{f} , {tag}_{x} ) = 0\end{matrix} \} .$$

Output ct=(x, tagₓ, WE.ct).
μ:=Dec(sk_{ƒ}, ct): Output μ:=WE.Dec(WE.ct, (ƒ, tag_{ƒ}, π)).

Theorem 5.1. Assuming witness encryption for NP, statistically sound NIZK for NP, statistically binding commitments and a functional tag system for circuits there exists an adaptively secure ABE for circuits.

In particular, the above holds assuming witness encryption for NP, statistically sound NIZK for NP, and one-way functions. Alternately, the above holds assuming witness encryption for NP and any one of: (1) hardness of factoring, or (2) the decisional linear assumption in bilinear groups, or (3) the learning with errors (LWE) assumption. Lastly, the above holds just assuming evasive LWE.

### Technical Implementations

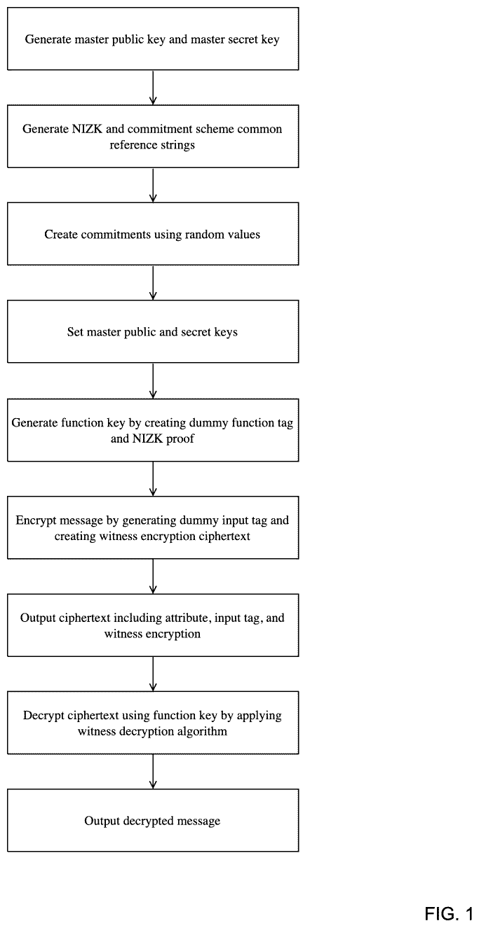

Referring to FIG. 1, the cryptographic process begins with the generation of fundamental cryptographic parameters that establish the security foundation for the entire system. The process initiates with the generation of a master public key and master secret key, which serve as the root cryptographic materials for subsequent operations. Following the master key generation, the process advances to generating Non-Interactive Zero-Knowledge (NIZK) and commitment scheme common reference strings, which provide the cryptographic infrastructure necessary for proof verification and commitment operations throughout the encryption and decryption procedures.

The cryptographic process continues with the creation of commitments using random values, establishing cryptographic bindings that maintain security properties while enabling selective revelation of information. The master public and secret keys are then formally established within the system's memory structures, creating the foundational key material that enables all subsequent cryptographic operations. The process architecture demonstrates how these initial setup phases create the necessary cryptographic environment for implementing advanced encryption schemes that can operate on complex computational problems.

With continued reference to FIG. 1, the process advances to function key generation, which involves creating a dummy function tag and generating a NIZK proof that validates the relationship between the function and the underlying cryptographic parameters. The function key generation phase establishes the cryptographic credentials necessary for authorized decryption operations, ensuring that only entities possessing valid function keys can successfully decrypt messages encrypted for specific attributes. The dummy function tag serves as a cryptographic identifier that enables the system to verify function authenticity without revealing sensitive information about the underlying computational relationships.

The encryption phase of the process involves generating a dummy input tag and creating witness encryption ciphertext, which encapsulates the message μ for a specific attribute x using sophisticated cryptographic techniques. The witness encryption ciphertext creation process integrates multiple cryptographic primitives to ensure that decryption can only occur when specific computational conditions are satisfied. The dummy input tag generation creates cryptographic markers that enable the system to verify attribute relationships while maintaining privacy properties essential for secure communication.

As further shown in FIG. 1, the process outputs ciphertext that includes the attribute, input tag, and witness encryption components, creating a comprehensive encrypted package that contains all necessary information for authorized decryption. The ciphertext structure enables recipients to identify the relevant cryptographic parameters while ensuring that the underlying message remains protected until proper decryption credentials are provided. The output phase consolidates all cryptographic components into a unified structure that can be transmitted or stored while maintaining security properties.

The decryption phase applies a witness decryption algorithm using the function key, demonstrating how the cryptographic process enables selective access to encrypted information based on computational proof requirements. The witness decryption algorithm verifies that the decrypting entity possesses valid credentials and satisfies the computational requirements embedded within the encryption structure. The process concludes with outputting the decrypted message, completing the cryptographic cycle from initial key generation through successful message recovery.

The cryptographic framework shown in FIG. 1 can accommodate various witness encryption implementations based on NP-complete problems, including Boolean Satisfiability Problem (SAT) variants where decryption requires finding a satisfying assignment to a Boolean formula. In SAT-based implementations, the witness encryption system encodes Boolean formulas within the cryptographic structure, requiring decrypting entities to demonstrate knowledge of variable assignments that satisfy the specified logical constraints. The SAT problem integration leverages the computational complexity of Boolean satisfiability to create cryptographic barriers that can only be overcome by entities possessing valid solution witnesses.

The subset-sum problem provides another computational foundation that can be integrated into the cryptographic process architecture, where decryption requires finding a subset of integers that sum to a specific target value. Subset-sum based witness encryption implementations encode integer sets and target values within the cryptographic parameters, creating computational challenges that must be solved to enable successful decryption. The subset-sum integration demonstrates how the cryptographic framework can accommodate different NP-complete problems while maintaining consistent operational procedures for key generation, encryption, and decryption phases.

### Modular Architecture Design

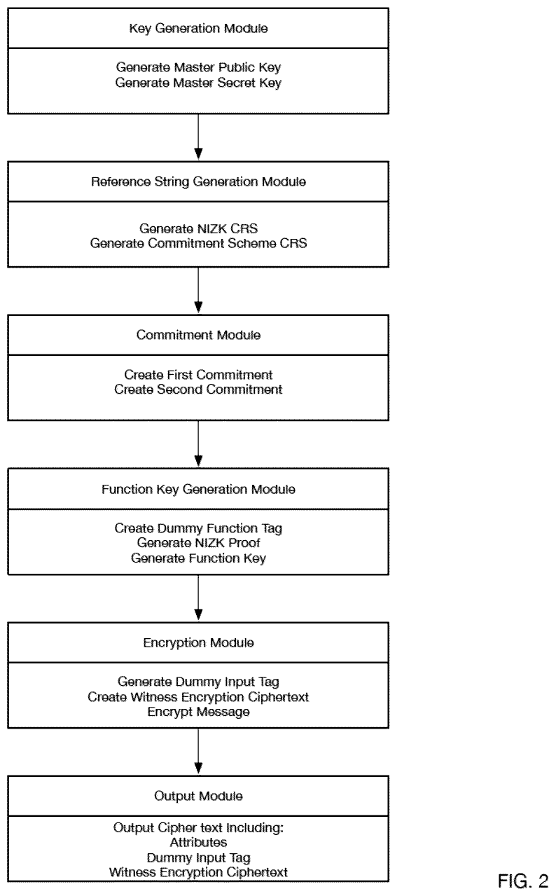

Referring to FIG. 2, the modular architecture provides a comprehensive framework for implementing witness encryption through distinct processing modules that operate in coordinated sequence. The Key Generation Module initiates the cryptographic process by generating a master public key and a master secret key, establishing the foundational cryptographic parameters for the entire system. This module operates independently from other components, allowing for secure key generation in isolated environments where cryptographic security may be enhanced through physical or logical separation. The master key generation process involves sophisticated random number generation and cryptographic parameter establishment that forms the basis for all subsequent cryptographic operations within the modular architecture.

The Reference String Generation Module follows the key generation phase and handles the creation of cryptographic reference strings that support advanced cryptographic protocols. This module generates a non-interactive zero-knowledge (NIZK) common reference string NIZK.crs using a cryptographically secure random number generator, providing the foundational parameters for zero-knowledge proof systems. Additionally, the module generates a commitment scheme common reference string Com.crs using a cryptographically secure random number generator, establishing the parameters for cryptographic commitment operations. The modular design allows these reference string generation operations to be performed independently, enabling distributed deployment scenarios where different entities may be responsible for generating different cryptographic parameters while maintaining overall system security.

With continued reference to FIG. 2, the Commitment Module processes the generated reference strings to create specific cryptographic commitments that serve as building blocks for the witness encryption scheme. The module generates first and second random values r₀ and r₁ from the set {0, 1}^{λ} using a cryptographically secure random number generator, ensuring that the randomness used in commitment generation meets cryptographic security standards. The module creates a first commitment com₀ by computationally committing a zero value using the commitment scheme common reference string and the first random value r₀, establishing a cryptographic binding to a known value. Furthermore, the module creates a second commitment com₁ by computationally committing a string of zeros of length [symbol] (λ) using the commitment scheme common reference string and the second random value r₁, providing additional cryptographic structure for the witness encryption scheme.

The modular architecture incorporates indistinguishability obfuscation (iO) based construction principles throughout the processing modules, enabling the system to obfuscate circuits that check witness validity for NP statements. This iO-based approach allows the Function Key Generation Module to create obfuscated programs that can verify witness validity without revealing the internal logic of the verification process. The obfuscation techniques integrated into the modular design provide computational indistinguishability between functionally equivalent circuits, ensuring that adversaries cannot distinguish between different witness verification circuits based on their obfuscated representations. The modular separation of iO-based components allows for independent optimization and security analysis of obfuscation operations while maintaining integration with other cryptographic modules.

As further shown in FIG. 2, the Function Key Generation Module builds upon the outputs from previous modules to create function-specific cryptographic keys. This module creates a dummy function tag and generates NIZK proof components that demonstrate knowledge of cryptographic secrets without revealing the secrets themselves. The modular design enables this module to operate with inputs from multiple previous modules while producing outputs that can be consumed by subsequent modules in the processing chain. The module sets the master public key mpk to include Com.crs, NIZK.crs, com₀, and com₁, consolidating the cryptographic parameters generated by previous modules into a unified public key structure. Additionally, the module sets the master secret key msk to be r₀, establishing the private cryptographic material that corresponds to the public key components.

The Encryption Module represents the culmination of the modular processing chain, utilizing outputs from all previous modules to perform witness encryption operations. This module generates a dummy input tag and creates witness encryption ciphertext through sophisticated cryptographic operations that bind the encrypted message to specific witness requirements. The modular architecture enables this module to access cryptographic parameters and keys generated by previous modules while maintaining clear separation of concerns and responsibilities. The module supports multi-instance encryption capabilities where decryption becomes possible if a valid witness exists for one or more of multiple NP statement instances, providing flexibility in witness verification scenarios.

The multi-instance support capabilities enhance the modular design by allowing the system to handle complex cryptographic scenarios where multiple alternative witnesses may satisfy decryption requirements. The modular architecture accommodates this functionality through flexible interfaces between modules that can process multiple NP statement instances simultaneously. Each module in the architecture can be configured to handle multiple instances of cryptographic operations, enabling parallel processing of different witness verification scenarios. The Output Module consolidates results from the encryption operations and formats the final ciphertext output, including attributes, dummy input tag, and witness encryption ciphertext components that collectively represent the encrypted message bound to witness requirements.

The modular separation of functionality provides significant advantages for system deployment, maintenance, and security analysis. Each module can be independently verified, tested, and optimized without affecting the operation of other modules, provided that the interfaces between modules remain consistent. The architecture supports distributed deployment scenarios where different modules may execute on different computing systems or in different security domains, enabling flexible system configurations that can adapt to various operational requirements. The modular design also facilitates the integration of different cryptographic implementations, allowing system operators to substitute alternative implementations of specific modules while maintaining compatibility with the overall architecture.

### Detailed Method Implementation

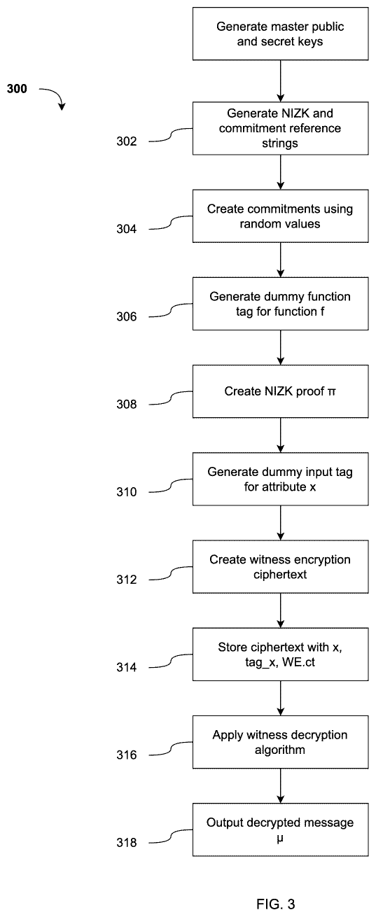

Referring to FIG. 3, a method 300 provides a comprehensive implementation of attribute-based witness encryption with enhanced security features. The method 300 begins with step 302, which involves generating NIZK and commitment reference strings that serve as foundational cryptographic parameters for the entire encryption process. In some cases, step 302 utilizes cryptographically secure random number generators to produce a non-interactive zero-knowledge common reference string NIZK.crs and a commitment scheme common reference string Com.crs. The generation process in step 302 may incorporate lattice-based cryptographic primitives, where the common reference strings are derived from hard lattice problems such as the Learning With Errors (LWE) problem to provide post-quantum security resistance. The lattice-based approach in step 302 ensures that the cryptographic foundations remain secure against both classical and quantum adversaries, making the witness encryption system resilient to future quantum computing threats.

The method 300 continues to step 304, where commitments are created using random values generated through cryptographically secure processes. Step 304 involves generating first and second random values r₀ and r₁ from the set {0, 1}^{λ} using a cryptographically secure random number generator, followed by creating a first commitment com₀ by computationally committing a zero value using the commitment scheme common reference string and the first random value r₀. In some cases, step 304 also creates a second commitment com₁ by computationally committing a string of zeros of length [symbol] (λ) using the commitment scheme common reference string and the second random value r₁. The commitment generation process in step 304 may utilize lattice-based commitment schemes that derive their security from the hardness of lattice problems, providing computational hiding and binding properties that remain secure against quantum attacks. The lattice-based commitments in step 304 may employ techniques such as SIS (Short Integer Solution) or LWE-based constructions to ensure long-term security.

As shown in FIG. 3, step 306 involves generating a dummy function tag for function f, which represents a fundamental component of the attribute-based witness encryption implementation. Step 306 generates a dummy function tag tag_{ƒ} for the function ƒ using a function tag system implemented in software, wherein the dummy function tag tag_{ƒ} comprises three random values t₀, t₁, t₂ from the set {0, 1}^{λ} generated using a cryptographically secure random number generator. The dummy function tag generation in step 306 may incorporate attribute-based witness encryption (ABWE) principles, where the tag generation process considers specific user attributes rather than relying solely on a single witness. In some cases, step 306 implements lattice-based pseudorandom functions for generating the random values, where the pseudorandom function evaluation relies on the hardness of lattice problems such as LWE to ensure unpredictability and security. The attribute-based approach in step 306 allows for more flexible access control mechanisms, where decryption capabilities can be tied to combinations of user attributes, roles, or contextual information.

The method 300 proceeds to step 308, which creates a NIZK proof that serves as a cryptographic attestation for the validity of the encryption process. Step 308 creates the NIZK proof π using NIZK.crs, where the proof is computationally associated with an NP relation NIZK.R that includes a statement \tilde{x}=(Com.crs, com₀, com₁, ƒ, tag_{ƒ}) and a witness \tilde{w}=r₀. The NIZK proof generation in step 308 may utilize lattice-based zero-knowledge proof systems that provide security against quantum adversaries while maintaining the non-interactive property. In some cases, step 308 implements attribute-based proof generation where the NIZK proof incorporates multiple user attributes and their relationships, allowing for complex access policies to be encoded within the proof structure. The lattice-based NIZK construction in step 308 may employ techniques such as Fiat-Shamir transformations applied to lattice-based sigma protocols, or more advanced constructions based on structured lattices that provide efficient proof generation and verification.

With continued reference to FIG. 3, step 310 generates a dummy input tag for attribute x, which forms a component of the attribute-based encryption scheme. Step 310 generates a dummy input tag tagₓ for the attribute x comprising a somewhere equivocal pseudorandom function key key and a garbled input i derived from \tilde{x} using cryptographic operations. The dummy input tag generation in step 310 may implement attribute-based witness encryption where the tag incorporates multiple user attributes and their hierarchical relationships, enabling fine-grained access control based on attribute combinations. In some cases, step 310 utilizes lattice-based pseudorandom functions where the somewhere equivocal property is achieved through lattice trapdoor functions that allow for controlled equivocation while maintaining security under the LWE assumption. The attribute-based tag generation in step 310 may support complex attribute policies where users with different attribute sets can access the same encrypted content if their attributes satisfy the specified policy conditions.

The method 300 advances to step 312, where a witness encryption ciphertext is created using the previously generated cryptographic components. Step 312 creates a witness encryption ciphertext WE.ct by computationally encrypting μ using a witness encryption scheme WE.Enc implemented in software stored in computer memory, where the encryption is associated with a relation WE.R that includes computational verification of the NIZK proof π, a condition that ƒ(x)=1, and a condition that a function Trigger(tag ƒ, tagₓ)=0. The witness encryption implementation in step 312 may utilize lattice-based constructions where the underlying security relies on the hardness of lattice problems such as LWE, providing post-quantum security guarantees. In some cases, step 312 implements attribute-based witness encryption where the encryption process considers multiple user attributes and their relationships, allowing for decryption only when the decryptor possesses attributes that satisfy the specified policy encoded in the witness relation. The lattice-based witness encryption in step 312 may employ techniques such as attribute-based encryption over lattices combined with witness encryption principles to achieve both attribute-based access control and witness-based decryption capabilities.

As further shown in FIG. 3, step 314 stores the ciphertext with x, tagₓ, and WE.ct, consolidating the encrypted data and associated metadata for subsequent processing. Step 314 stores a ciphertext ct that includes x, tagₓ, and WE.ct in computer memory of the computing device, where the storage process may incorporate additional security measures such as integrity protection and access controls. The storage implementation in step 314 may utilize secure memory allocation techniques that protect against side-channel attacks and memory-based vulnerabilities. In some cases, step 314 implements distributed storage mechanisms where different components of the ciphertext are stored across multiple secure locations, enhancing the overall security and availability of the encrypted data. The attribute-based storage in step 314 may include metadata that describes the attribute policies and access conditions, enabling efficient policy evaluation during decryption attempts.

The method 300 continues to step 316, where a witness decryption algorithm is applied to recover the original message. Step 316 applies a witness decryption algorithm WE.Dec implemented in software to the witness encryption ciphertext WE.ct using (ƒ, tag, π) as the witness, where the decryption process verifies the validity of the witness components before releasing the encrypted message. The witness decryption in step 316 may implement lattice-based decryption algorithms that leverage the structure of lattice problems to provide efficient decryption while maintaining security against quantum attacks. In some cases, step 316 incorporates attribute-based decryption where the decryption algorithm evaluates multiple user attributes and their relationships to determine whether the decryptor possesses the attributes to access the encrypted content. The lattice-based decryption in step 316 may utilize techniques such as Gaussian sampling and lattice basis reduction to perform the decryption operations efficiently while preserving the security properties of the underlying lattice problems.

Finally, the method 300 concludes with step 318, where the decrypted message is output and stored for use by the requesting entity. Step 318 stores the decrypted message μ in computer memory, completing the witness encryption and decryption cycle. The output process in step 318 may include additional verification steps to ensure the integrity and authenticity of the decrypted message. In some cases, step 318 implements secure output mechanisms that protect the decrypted message from unauthorized access or modification during the output process. The attribute-based output in step 318 may include logging and auditing capabilities that record which attributes were used for successful decryption, providing accountability and traceability for access control decisions. The lattice-based implementation in step 318 ensures that the decrypted message maintains its integrity and authenticity through cryptographic verification processes that rely on the hardness of lattice problems.

### Trigger Function Processing

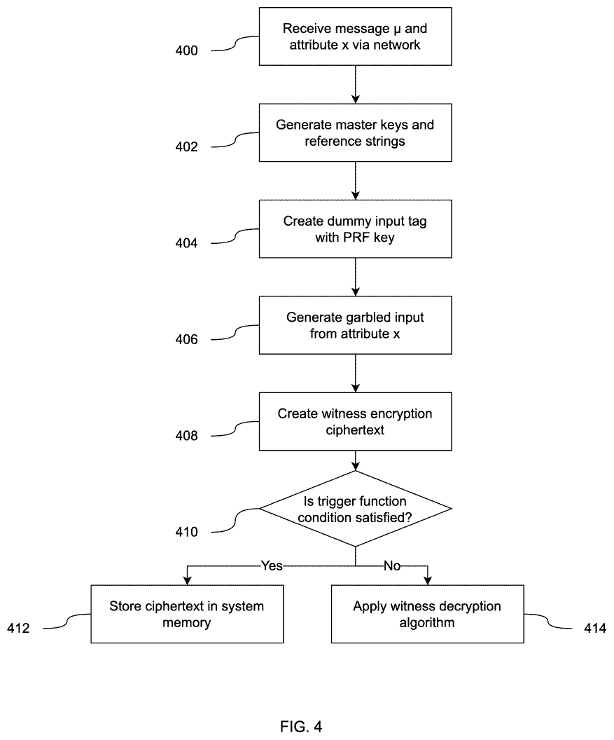

Referring to FIG. 4, the trigger function evaluation process begins with a step 400 that involves receiving a message μ and attribute x via network. The system architecture processes these inputs through a series of computational steps that implement sophisticated decision logic for conditional processing paths. In some cases, the trigger function mechanism serves as a gatekeeper that determines whether decryption operations proceed or whether ciphertext storage operations are initiated. The trigger function evaluation leverages cryptographic primitives to create secure conditional branching within the witness encryption framework.

The process continues to a step 402 where master keys and reference strings are generated. This step establishes the cryptographic foundation for subsequent trigger function operations by creating the necessary parameters for both zero-knowledge proof verification and witness encryption operations. In some cases, the master key generation process incorporates non-interactive zero-knowledge (NIZK) common reference strings that enable computational verification of a NIZK proof π within the trigger function logic. The reference string generation may utilize cryptographically secure random number generators to ensure the integrity of the trigger function's decision-making capabilities.

Following the key generation phase, the system proceeds to a step 404 where a dummy input tag with PRF key is created. The dummy input tag generation process involves generating a dummy input tag tagₓ for the attribute x comprising a somewhere equivocal pseudorandom function key key and a garbled input \tilde{x} derived from x using cryptographic operations. In some cases, the pseudorandom function key serves as a critical component in the trigger function's ability to perform secure computations while maintaining the privacy properties of the witness encryption scheme. The garbled input derivation process may involve complex cryptographic transformations that preserve the semantic meaning of the attribute while enabling secure evaluation within the trigger function framework.

The trigger function processing architecture advances to a step 406 where garbled input from attribute x is generated. This step implements sophisticated garbling techniques that transform the input attribute into a format suitable for secure computation within the trigger function mechanism. In some cases, the garbled input generation process utilizes semi-adaptive blind circuit techniques that enable the trigger function to evaluate conditions without revealing sensitive information about the underlying attributes. The garbling process may incorporate cryptographic masking operations that ensure the confidentiality of the input data while preserving the computational properties needed for trigger function evaluation.

The system then proceeds to a step 408 where a witness encryption ciphertext is created. This step involves creating a witness encryption ciphertext WE.ct by computationally encrypting μ using a witness encryption scheme WE.Enc implemented in software stored in a computer memory of the computing device, where the encryption is associated with a relation WE.R that includes multiple conditional components. The witness encryption relation incorporates computational verification of a NIZK proof π, a condition that ƒ(x)=1, and a condition that a function Trigger(tag ƒ, tagₓ)=0. In some cases, the witness encryption ciphertext creation process integrates zero-knowledge proofs where decryption operations involve providing a valid zero-knowledge proof of witness knowledge without revealing the witness itself.

The trigger function evaluation reaches a decision point at a step 410, which evaluates whether a trigger function condition is satisfied. This decision logic implements the core computational mechanism of the trigger function, wherein the Trigger function comprises computing a pseudorandom function on key and t₀ to derive a pad p, performing a bitwise XOR operation of p with t₁ to derive a garbled circuit \tilde{C}, and evaluating garbled circuit \tilde{C} on the garbled input \tilde{x} and outputting 1 if the result matches t₂. In some cases, the trigger function condition evaluation may implement functional witness encryption approaches where decryption operations are tied to a specific function of the witness rather than the witness itself. The decision logic may incorporate sophisticated cryptographic protocols that enable secure evaluation of complex conditional statements while maintaining the privacy and security properties of the overall system.

When the trigger function condition is satisfied, as indicated by the “Yes” branch from step 410, the process proceeds to a step 412 where the ciphertext is stored in system memory. This storage operation involves storing a ciphertext ct that includes x, tagₓ, and WE.ct in the computer memory of the computing device. In some cases, the ciphertext storage process may implement additional security measures such as encrypted storage or distributed storage mechanisms to enhance the overall security of the system. The storage operation may also involve indexing and cataloging mechanisms that enable efficient retrieval of ciphertext data for subsequent decryption operations.

Alternatively, when the trigger function condition is not satisfied, as indicated by the “No” branch from step 410, the process proceeds to a step 414 where a witness decryption algorithm is applied. This conditional processing path enables immediate decryption operations when the trigger function determines that the conditions for delayed processing are not met. In some cases, the witness decryption algorithm application may involve complex cryptographic computations that verify the validity of witness data while extracting the encrypted message content. The decryption process may incorporate zero-knowledge proof verification mechanisms that ensure the authenticity of the decryption operation without compromising the privacy properties of the witness encryption scheme.

The trigger function processing mechanism demonstrates how zero-knowledge proof integration enhances the security and functionality of the trigger mechanism by enabling verifiable computation without revealing sensitive information. The computational verification of NIZK proofs within the trigger function logic provides cryptographic assurance that the trigger conditions are evaluated correctly while maintaining the privacy of the underlying data. In some cases, the zero-knowledge proof integration may involve sophisticated proof systems that enable efficient verification of complex statements about the encrypted data and associated attributes.

The functional witness encryption variant approaches further enhance the trigger mechanism's capabilities by enabling decryption operations that are tied to specific functions of the witness data rather than the witness itself. This approach provides greater flexibility in defining trigger conditions and enables more sophisticated access control mechanisms within the witness encryption framework. In some cases, the functional witness encryption implementation may involve complex function evaluation protocols that enable secure computation of arbitrary functions over encrypted data while preserving the privacy and security properties of the overall system.

### Network-Based Operations

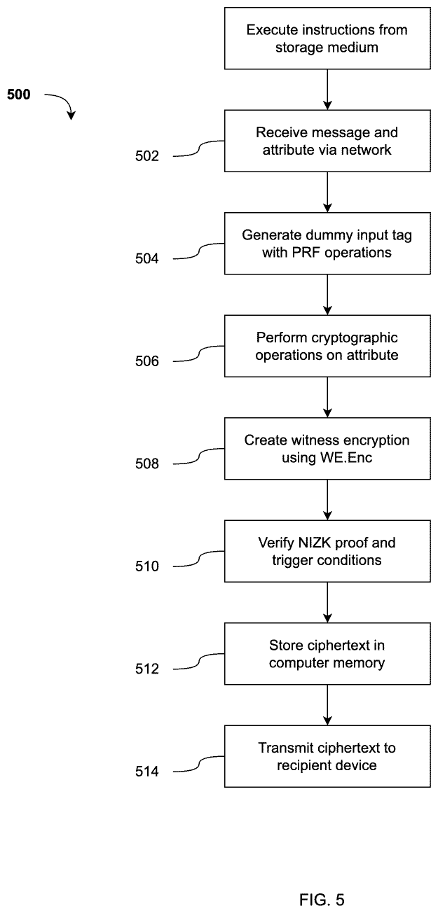

Referring to FIG. 5, a method 500 may be implemented to facilitate network-enabled cryptographic operations for distributed witness encryption systems. The method 500 begins with step 502, which involves receiving a message and attribute via network interface from remote client devices or distributed computing nodes. In some cases, the network reception process may utilize secure communication protocols to maintain data integrity during transmission across potentially untrusted network infrastructure. The step 502 may incorporate authentication mechanisms to verify the identity of message senders and validate the authenticity of received attributes before processing. Network-based message reception may support various communication protocols including TCP/IP, HTTP/HTTPS, or specialized cryptographic messaging protocols designed for secure multi-party computation environments.

The method 500 continues to step 504, where a dummy input tag is generated with PRF operations to support the distributed cryptographic framework. The functional tag system may be configured for generating tagₓ←DInputTag(1^{λ}, x) and tag_{ƒ}←DFunctionTag(1^{λ}, ƒ), where the security parameter A determines the cryptographic strength of the generated tags. In some cases, the PRF operations in step 504 may utilize somewhere equivocal pseudorandom functions that enable selective equivocation properties for enhanced security in distributed environments. The dummy input tag generation process may incorporate network-synchronized randomness sources to ensure consistency across distributed nodes while maintaining the unpredictability properties required for cryptographic security. The PRF operations may leverage multilinear maps as the underlying cryptographic primitive for security, providing the mathematical foundation for complex cryptographic relationships between multiple parties in the distributed system.

With continued reference to FIG. 5, step 506 performs cryptographic operations on the attribute data received through the network interface. The cryptographic operations may include attribute validation, normalization, and encoding processes that prepare the attribute data for integration with the witness encryption scheme. In some cases, the attribute processing may involve distributed computation across multiple network nodes to enhance security through computation distribution. The garbled circuit implementation in step 506 may utilize semi-adaptive blind circuit constructions that provide enhanced security properties for network-based operations. Semi-adaptive blind circuits may offer computational efficiency advantages in distributed environments by allowing partial pre-computation of circuit components before the complete input specification becomes available.

The method 500 advances to step 508, which creates witness encryption using WE.Enc operations that integrate the network-received data with the cryptographic framework. The witness encryption creation process may utilize multilinear maps-based constructions that provide the mathematical foundation for secure multi-party witness verification across distributed network nodes. In some cases, the WE.Enc operations may implement extractable witness encryption variants that guarantee knowledge extraction from successful decryption attempts, providing additional security assurances in network-based deployment scenarios. The extractable witness encryption implementation may incorporate zero-knowledge proof systems that enable network participants to demonstrate possession of valid witnesses without revealing the underlying witness information to other network entities. The step 508 may coordinate with distributed key management systems to ensure proper cryptographic parameter distribution across the network infrastructure.

As further shown in FIG. 5, step 510 performs verification of NIZK proof and trigger conditions within the network-enabled cryptographic system. The verification process may involve distributed validation across multiple network nodes to prevent single points of failure and enhance the overall security posture of the system. In some cases, the NIZK proof verification may utilize network-synchronized common reference strings that enable consistent proof validation across geographically distributed verification entities. The trigger condition evaluation in step 510 may incorporate network latency considerations and timeout mechanisms to handle potential communication delays or node failures in distributed environments. The verification process may implement consensus mechanisms that require agreement from multiple network participants before accepting proof validity, thereby strengthening the security guarantees of the extractable witness encryption system.

The method 500 continues with step 512, where the ciphertext is stored in computer memory systems that may be distributed across multiple network locations for redundancy and availability. The distributed storage approach may utilize replication strategies that maintain ciphertext availability even in the presence of network partitions or node failures. In some cases, the storage process may implement cryptographic integrity checks that detect unauthorized modifications to stored ciphertext data across the distributed network infrastructure. The memory storage operations may coordinate with network-based backup systems to ensure long-term preservation of encrypted data while maintaining the security properties of the underlying witness encryption scheme. The step 512 may incorporate access control mechanisms that regulate which network entities can retrieve stored ciphertext data based on their cryptographic credentials and authorization levels.

Finally, the method 500 concludes with step 514, which transmits the ciphertext to a recipient device through the network infrastructure. The transmission process may utilize secure communication channels that preserve the confidentiality and integrity of the ciphertext during network transit. In some cases, the ciphertext transmission may implement forward secrecy properties that protect against future compromise of network communication keys. The recipient device communication may support various network topologies including point-to-point, broadcast, and multicast distribution patterns depending on the specific application requirements. The step 514 may incorporate delivery confirmation mechanisms that provide cryptographic proof of successful ciphertext delivery to intended recipients, enabling audit trails and accountability in distributed cryptographic systems. The network transmission process may integrate with existing network security infrastructure including firewalls, intrusion detection systems, and network monitoring tools to maintain comprehensive security coverage throughout the cryptographic operation lifecycle.

### Distributed System Architecture

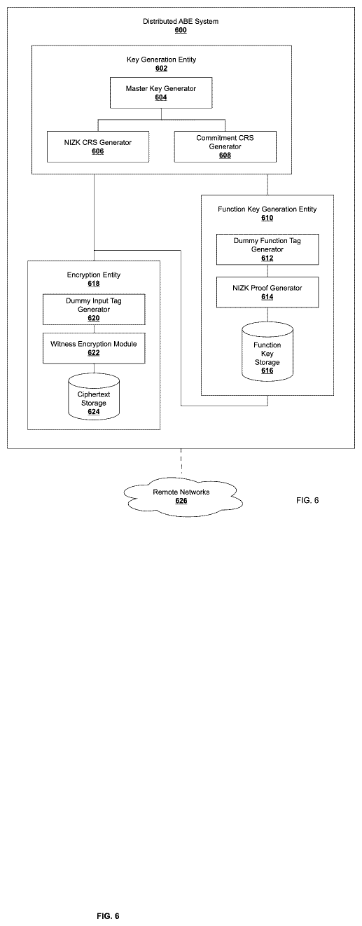

Referring to FIG. 6, a Distributed ABE System 600 provides a comprehensive framework for implementing attribute-based encryption across multiple computational entities. The Distributed ABE System 600 may be configured to support offline witness encryption with a setup phase that moves heavy computations offline for improved efficiency. In some cases, the distributed architecture enables reusable encryption allowing multiple messages to be encrypted under the same NP statement instance. The system architecture separates cryptographic operations across distinct entities that communicate with each other to perform the complete encryption and decryption processes.

The Distributed ABE System 600 includes a Key Generation Entity 602 that serves as the foundational component for establishing cryptographic parameters. A Master Key Generator 604 within the Key Generation Entity 602 generates the master public key and master secret key and transmits the master public key to other entities in the distributed system. The Key Generation Entity 602 further comprises a NIZK CRS Generator 606 that produces non-interactive zero-knowledge common reference strings for computational verification of NIZK proofs π throughout the system. Additionally, a Commitment CRS Generator 608 generates commitment scheme common reference strings that enable the creation of cryptographic commitments using random values. The Master Key Generator 604 may coordinate with both the NIZK CRS Generator 606 and the Commitment CRS Generator 608 to establish the complete set of public parameters needed for the distributed encryption scheme.

The system architecture incorporates a Function Key Generation Entity 610 that receives the master public key and generates function keys for authorized functions within the attribute-based encryption scheme. A Dummy Function Tag Generator 612 within the Function Key Generation Entity 610 creates dummy function tags tag_{ƒ} for functions ƒ, where each tag comprises three random values t₀, t₁, t₂ generated using cryptographically secure random number generators. The Function Key Generation Entity 610 also includes a NIZK Proof Generator 614 that creates NIZK proofs π associated with NP relations, enabling computational verification processes throughout the distributed system. Function Key Storage 616 connected to the Function Key Generation Entity 610 maintains the generated function keys in a secure manner, allowing for efficient retrieval and distribution to authorized entities. The offline computation capabilities of the Function Key Generation Entity 610 enable the pre-computation of function keys before encryption requests are received, thereby improving overall system efficiency.

As further shown in FIG. 6, an Encryption Entity 618 receives the master public key and performs the encryption operations for messages and attributes received from client devices. The Encryption Entity 618 contains a Dummy Input Tag Generator 620 that generates dummy input tags tagₓ for attributes x, where each tag comprises a somewhere equivocal pseudorandom function key key and a garbled input \tilde{x} derived from x using cryptographic operations. A Witness Encryption Module 622 within the Encryption Entity 618 creates witness encryption ciphertexts WE.ct by computationally encrypting messages μ using a witness encryption scheme WE.Enc implemented in software. The encryption process may be associated with a relation WE.R that includes computational verification of NIZK proofs π, conditions that ƒ(x)=1, and conditions that a function Trigger(tag_{ƒ}, tagₓ)=0. Ciphertext Storage 624 connected to the Encryption Entity 618 stores ciphertexts ct that include attributes x, dummy input tags tagₓ, and witness encryption ciphertexts WE.ct in computer memory.

The Trigger function implemented within the distributed system comprises multiple computational steps that enable secure attribute-based access control. The function computes a pseudorandom function on the key key and to t₀ derive a pad p, performs a bitwise XOR operation of p with t₁ to derive a garbled circuit \tilde{C}, and evaluates the garbled circuit \tilde{C} on the garbled input \tilde{x}, outputting 1 if the result matches t₂. This trigger mechanism enables the system to determine whether decryption should be permitted based on the relationship between function tags and input tags. The distributed nature of the system allows different entities to handle different aspects of the trigger computation, thereby distributing computational load and enhancing security through separation of concerns.

Remote Networks 626 facilitate communication between the various entities within the Distributed ABE System 600, enabling the transmission of public keys, function keys, ciphertexts, and other cryptographic materials. The network infrastructure supports the distributed operation by allowing entities to be geographically separated while maintaining secure communication channels. In some cases, the Remote Networks 626 may include multiple network protocols and security layers to ensure the integrity and confidentiality of transmitted cryptographic data. The reusable encryption capabilities of the system enable multiple messages to be encrypted under the same NP statement instance, with the distributed entities coordinating to maintain consistency and security across multiple encryption operations. The offline setup phase implemented across the distributed entities allows for the pre-computation of cryptographic parameters, tags, and proofs, thereby reducing the computational overhead during real-time encryption and decryption operations.

### Functional Tag System

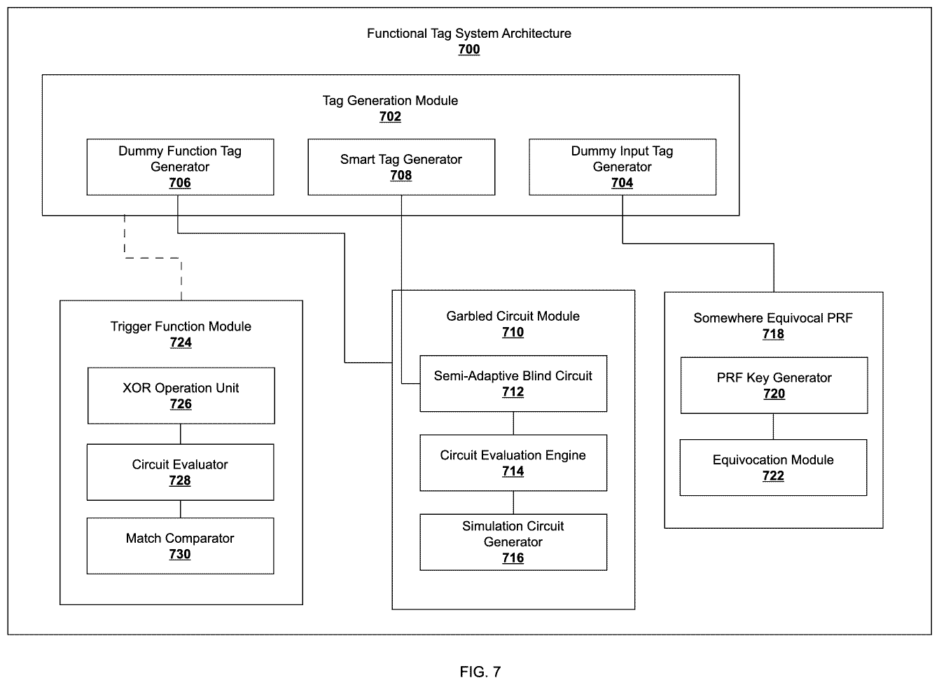

Referring to FIG. 7, a Functional Tag System Architecture 700 provides a comprehensive framework for generating and managing cryptographic tags within the attribute-based encryption scheme. The Functional Tag System Architecture 700 comprises multiple interconnected modules that work in coordination to enable secure tag generation, circuit evaluation, and trigger function operations. The architecture facilitates the implementation of witness pseudorandom functions (PRF) that combine witness encryption concepts with pseudorandom function evaluation, thereby enhancing the cryptographic security and functionality of the overall system. In some cases, the Functional Tag System Architecture 700 may be deployed across distributed computing environments to optimize performance and scalability.

A Tag Generation Module 702 serves as the central component for creating various types of cryptographic tags used throughout the encryption and decryption processes. The Tag Generation Module 702 contains three specialized generators that produce different categories of tags based on the specific cryptographic requirements. A Dummy Input Tag Generator 704 within the Tag Generation Module 702 generates dummy input tags for attributes, creating cryptographic representations that obscure the actual input values while maintaining the necessary computational properties. A Dummy Function Tag Generator 706 produces dummy function tags that correspond to specific functions within the attribute-based encryption scheme, enabling secure function evaluation without revealing the underlying function structure. A Smart Tag Generator 708 creates intelligent tags that incorporate additional cryptographic properties and may adapt based on the specific context or security requirements of the encryption operation.

The Functional Tag System Architecture 700 incorporates a Garbled Circuit Module 710 that implements advanced circuit garbling techniques for secure computation. A Semi-Adaptive Blind Circuit 712 within the Garbled Circuit Module 710 provides a specialized garbling scheme that maintains security properties while allowing for efficient evaluation. The semi-adaptive blind garbled circuit scheme satisfies a blindness property such that for any fixed garbling secret key sk and input x, the distribution of SimCircuit(sk, x, Uₘ) may be identical to the uniform distribution over {0, 1}^{l}, where SimCircuit represents a simulated circuit generation function, Uₘ denotes the uniform distribution over m-bit strings, and l corresponds to the garbled circuit size. A Circuit Evaluation Engine 714 processes the garbled circuits and executes the necessary computations on garbled inputs to produce the desired cryptographic outputs. A Simulation Circuit Generator 716 creates simulated circuits that maintain the same functional properties as the original circuits while providing additional security guarantees through the simulation paradigm.

As further shown in FIG. 7, a Somewhere Equivocal PRF 718 implements pseudorandom function capabilities with equivocation properties that enhance the security of the tag generation process. The Somewhere Equivocal PRF 718 enables the system to generate pseudorandom outputs that may be later equivocated to different values under specific conditions, providing flexibility in cryptographic protocols while maintaining security. A PRF Key Generator 720 within the Somewhere Equivocal PRF 718 produces cryptographic keys used for pseudorandom function evaluation, ensuring that the generated keys possess the necessary entropy and security properties. An Equivocation Module 722 manages the equivocation process, allowing the system to reveal alternative explanations for previously generated pseudorandom values when specific conditions are met, thereby supporting advanced cryptographic protocols that require this capability.

The Functional Tag System Architecture 700 includes a Trigger Function Module 724 that implements conditional logic for determining when specific cryptographic operations should be executed. The functional tag system includes a trigger function Trigger(tag_{ƒ}, tagₓ) that outputs either 0 or 1 based on the input tag tagₓ and function tag tag_{ƒ}, providing a mechanism for conditional access control within the encryption scheme. An XOR Operation Unit 726 within the Trigger Function Module 724 performs bitwise exclusive-or operations on cryptographic values, enabling the combination and manipulation of encrypted data streams. A Circuit Evaluator 728 executes the evaluation of garbled circuits within the trigger function context, determining whether specific trigger conditions have been satisfied. A Match Comparator 730 compares the results of circuit evaluations against predetermined values to determine the final output of the trigger function.

The semi-adaptive blind garbled circuit scheme further comprises an evaluation function Eval(\tilde{C}, \tilde{x}) that outputs the result of evaluating the garbled circuit \tilde{C} on the garbled input \tilde{x}. This evaluation function provides a standardized interface for circuit evaluation operations and ensures consistent behavior across different implementations of the garbled circuit scheme. In some cases, the evaluation function may incorporate additional security checks and validation procedures to prevent malicious manipulation of the evaluation process. The function may also support batch evaluation of multiple circuits simultaneously to improve computational efficiency in scenarios involving large numbers of cryptographic operations.

The method achieves adaptive security for attribute-based encryption by utilizing the functional tag system in conjunction with the semi-adaptive blind garbled circuit scheme. The adaptive security property ensures that the encryption scheme remains secure even when an adversary may adaptively choose which attributes and functions to attack based on previously observed information. The combination of the functional tag system and the garbled circuit scheme creates multiple layers of cryptographic protection that collectively provide strong security guarantees. In some cases, the adaptive security may be enhanced through the use of additional randomization techniques and security amplification methods implemented within the various modules of the Functional Tag System Architecture 700.

The witness encryption system may be implemented on blockchain platforms using smart contracts and committee nodes for practical deployment. Smart contracts deployed on blockchain networks may execute the various functions of the Functional Tag System Architecture 700 in a decentralized manner, providing transparency and immutability for the cryptographic operations. Committee nodes within the blockchain network may participate in the tag generation and circuit evaluation processes, distributing the computational load and enhancing the overall security through decentralization. The blockchain implementation may also provide audit trails for all cryptographic operations, enabling verification of the system's behavior and detection of any potential security violations. In some cases, the blockchain deployment may incorporate consensus mechanisms that ensure agreement among committee nodes regarding the validity of cryptographic operations and the correctness of generated tags and circuit evaluations.

### Client Computing Infrastructure

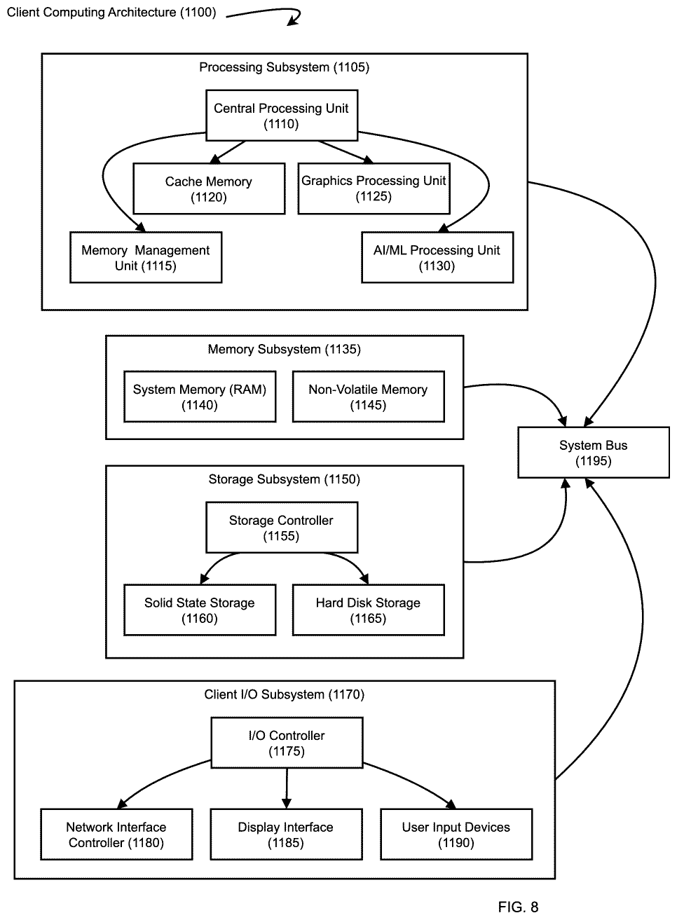

Referring to FIG. 8, a client computing architecture 1100 provides the computational foundation for implementing witness encryption systems with time-lock puzzle applications. The client computing architecture 1100 comprises multiple interconnected subsystems that work together to support the complex cryptographic operations involved in witness encryption schemes. In some cases, the client computing architecture 1100 may be configured to handle the computationally intensive operations associated with solving time-lock puzzles, where decryption operations involve solving computational puzzles that take predetermined time periods. The architecture enables distributed processing of cryptographic functions while maintaining security and performance characteristics suitable for witness encryption implementations.

A processing subsystem 1105 forms the computational core of the client computing architecture 1100 and includes several specialized processing components designed to handle different aspects of cryptographic operations. The processing subsystem 1105 coordinates the execution of witness encryption algorithms, including the generation of NIZK proofs, commitment schemes, and the evaluation of garbled circuits. In some cases, the processing subsystem 1105 may distribute computational tasks across multiple processing units to optimize performance for time-lock puzzle applications. The processing subsystem 1105 manages the execution of software implementations of witness decryption algorithms WE.Dec and handles the computational verification of NIZK proofs π associated with NP relations NIZK.R.

A central processing unit 1110 within the processing subsystem 1105 executes the primary computational logic for witness encryption operations, including the generation of cryptographically secure random number generators used for creating NIZK common reference strings NIZK.crs and commitment scheme common reference strings Com.crs. The central processing unit 1110 processes the creation of first and second random values r₀ and r₁ from the set {0, 1}^{λ} and manages the computational commitment operations for generating first commitments com₀ and second commitments com₁. In time-lock puzzle applications, the central processing unit 1110 may execute iterative computational processes that consume predetermined amounts of processing time, thereby implementing the temporal constraints inherent in time-lock encryption schemes. The central processing unit 1110 coordinates with other processing components to ensure efficient execution of witness encryption algorithms while maintaining the security properties of the cryptographic system.

A memory management unit 1115 controls access to memory resources and manages the secure storage of cryptographic keys and intermediate computational results. The memory management unit 1115 implements memory protection mechanisms to prevent unauthorized access to sensitive cryptographic material, including master secret keys msk set to values such as r₀ and function keys sk_{ƒ} stored as (ƒ, tag_{ƒ}, π). In some cases, the memory management unit 1115 may implement specialized memory allocation strategies for time-lock puzzle applications, where large amounts of intermediate computational state may need to be maintained during the puzzle-solving process. The memory management unit 1115 ensures that decrypted messages μ are stored securely in memory and that master public keys mpk including Com.crs, NIZK.crs, com₀, and com₁ are properly managed throughout the encryption and decryption processes.

Cache memory 1120 provides high-speed temporary storage for frequently accessed cryptographic data and computational results, improving the performance of witness encryption operations. The cache memory 1120 may store precomputed values used in the generation of dummy function tags tag_{ƒ} comprising three random values t₀, t₁, t₂ from the set {0, 1}^{λ}, enabling faster function key generation processes. In time-lock puzzle applications, the cache memory 1120 may be configured to store intermediate results of iterative computational processes, reducing the overall time needed to complete puzzle-solving operations while maintaining the temporal security properties of the system. The cache memory 1120 works in conjunction with the central processing unit 1110 to optimize the execution of cryptographic algorithms and reduce latency in witness encryption operations.

A graphics processing unit 1125 provides parallel processing capabilities that may be utilized for certain cryptographic operations within witness encryption systems, particularly those involving large-scale mathematical computations. The graphics processing unit 1125 may accelerate the evaluation of garbled circuits and the computation of pseudorandom functions used in witness encryption schemes. In some cases, the graphics processing unit 1125 may be employed to parallelize the computational work involved in time-lock puzzle solving, where multiple computational threads can work simultaneously on different aspects of the puzzle-solving process. The graphics processing unit 1125 may also support the generation of cryptographically secure random numbers and the execution of commitment scheme operations that benefit from parallel processing architectures.

An AI/ML processing unit 1130 provides specialized computational capabilities for machine learning and artificial intelligence operations that may be integrated with witness encryption systems. The AI/ML processing unit 1130 may be utilized to optimize the selection of cryptographic parameters, analyze the computational complexity of time-lock puzzles, or implement adaptive security mechanisms within witness encryption schemes. In some cases, the AI/ML processing unit 1130 may support the development of more efficient algorithms for witness encryption operations or provide predictive capabilities for estimating the computational time associated with specific time-lock puzzle configurations. The AI/ML processing unit 1130 may also contribute to the analysis of cryptographic performance metrics and the optimization of system parameters for different deployment scenarios.

A memory subsystem 1135 provides the primary data storage infrastructure for the client computing architecture 1100 and manages both volatile and non-volatile memory resources used in witness encryption operations. The memory subsystem 1135 coordinates the storage and retrieval of cryptographic keys, ciphertexts, and computational results across different memory technologies. In time-lock puzzle applications, the memory subsystem 1135 may need to maintain large amounts of computational state over extended time periods, requiring careful management of memory resources to ensure system stability and security. The memory subsystem 1135 implements security mechanisms to protect stored cryptographic material and ensures that sensitive data such as master secret keys and function keys are properly isolated from unauthorized access.

System memory 1140 within the memory subsystem 1135 provides volatile storage for active cryptographic operations and serves as the primary working memory for witness encryption algorithms. The system memory 1140 stores the runtime state of witness decryption algorithms WE.Dec and maintains the computational context for NIZK proof generation and verification processes. In some cases, the system memory 1140 may be configured with specialized memory protection features to prevent side-channel attacks and ensure the confidentiality of cryptographic operations. The system memory 1140 manages the storage of decrypted messages μ and provides temporary storage for intermediate results generated during the execution of witness encryption schemes.

Non-volatile memory 1145 provides persistent storage for cryptographic keys, configuration parameters, and other data that must be retained across system restarts and power cycles. The non-volatile memory 1145 may store master public keys mpk, function keys sk_{ƒ}, and other cryptographic material that forms the foundation of witness encryption operations. In time-lock puzzle applications, the non-volatile memory 1145 may maintain checkpoint data that allows puzzle-solving operations to resume after system interruptions, ensuring that computational progress is not lost during extended puzzle-solving processes. The non-volatile memory 1145 implements security features to protect stored cryptographic keys and may include hardware-based encryption to prevent unauthorized access to sensitive data.

A storage subsystem 1150 manages long-term data storage requirements for witness encryption systems and provides scalable storage solutions for cryptographic data, ciphertexts, and computational results. The storage subsystem 1150 coordinates between different storage technologies to optimize performance and capacity for various types of cryptographic data. In some cases, the storage subsystem 1150 may implement distributed storage architectures that enhance the reliability and availability of cryptographic data across multiple storage devices. The storage subsystem 1150 supports the storage of large datasets associated with time-lock puzzle applications, where extensive computational results may need to be preserved for verification or audit purposes.

A storage controller 1155 within the storage subsystem 1150 manages data access operations and coordinates between different storage devices to ensure optimal performance and reliability. The storage controller 1155 implements data integrity mechanisms to protect stored cryptographic data from corruption and may include error correction capabilities to maintain the accuracy of stored information. In time-lock puzzle applications, the storage controller 1155 may manage the storage of computational checkpoints and intermediate results, enabling efficient resumption of puzzle-solving operations after system interruptions. The storage controller 1155 coordinates with the memory subsystem 1135 to optimize data movement between different storage tiers and ensure efficient access to cryptographic data.

Solid state storage 1160 provides high-performance persistent storage for frequently accessed cryptographic data and offers fast read and write operations that benefit witness encryption systems. The solid state storage 1160 may store cryptographic libraries, precomputed tables, and other data structures that support efficient execution of witness encryption algorithms. In some cases, the solid state storage 1160 may be utilized to store intermediate results from time-lock puzzle computations, providing fast access to computational state during puzzle-solving operations. The solid state storage 1160 offers improved reliability and performance compared to traditional storage technologies, making the solid state storage 1160 suitable for mission-critical cryptographic applications.

Hard disk storage 1165 provides high-capacity storage for large datasets and archival data associated with witness encryption systems, offering cost-effective storage solutions for applications that generate substantial amounts of cryptographic data. The hard disk storage 1165 may store historical cryptographic data, audit logs, and backup copies of cryptographic keys and configuration data. In time-lock puzzle applications, the hard disk storage 1165 may maintain archives of completed puzzle solutions and associated computational data for verification and analysis purposes. The hard disk storage 1165 works in conjunction with the solid state storage 1160 to provide a tiered storage architecture that balances performance and capacity requirements.

A client I/O subsystem 1170 manages input and output operations for the client computing architecture 1100 and provides interfaces for communication with external systems and user interaction. The client I/O subsystem 1170 coordinates the transmission and reception of cryptographic data, including ciphertexts, public keys, and other information exchanged during witness encryption operations. In some cases, the client I/O subsystem 1170 may implement specialized protocols for secure communication of cryptographic data and may include hardware-based security features to protect data during transmission. The client I/O subsystem 1170 supports the integration of witness encryption systems with distributed computing environments and enables communication with remote cryptographic services.

An I/O controller 1175 within the client I/O subsystem 1170 manages the coordination of input and output operations across different interface types and ensures efficient data transfer between the client computing architecture 1100 and external systems. The I/O controller 1175 implements buffering and queuing mechanisms to optimize data transfer performance and may include security features to protect data during I/O operations. In time-lock puzzle applications, the I/O controller 1175 may manage the transmission of puzzle parameters and solutions between different system components, ensuring that computational results are properly communicated and verified. The I/O controller 1175 coordinates with other subsystems to ensure that I/O operations do not interfere with ongoing cryptographic computations.

A network interface controller 1180 provides network connectivity for the client computing architecture 1100 and enables communication with distributed witness encryption systems and remote cryptographic services. The network interface controller 1180 implements network protocols suitable for secure transmission of cryptographic data and may include hardware-based encryption capabilities to protect data during network transmission. In some cases, the network interface controller 1180 may support specialized protocols for distributed cryptographic operations, enabling coordination between multiple computing nodes in time-lock puzzle applications. The network interface controller 1180 manages the transmission of function keys, ciphertexts, and other cryptographic data between different components of distributed witness encryption systems.

A display interface 1185 provides visual output capabilities for the client computing architecture 1100 and enables user interaction with witness encryption systems through graphical interfaces. The display interface 1185 may present cryptographic operation status, system performance metrics, and user interface elements for configuring and monitoring witness encryption operations. In time-lock puzzle applications, the display interface 1185 may provide real-time feedback on puzzle-solving progress and estimated completion times, enabling users to monitor the status of long-running cryptographic operations. The display interface 1185 may also support the visualization of cryptographic data structures and system architecture diagrams for system administration and debugging purposes.

User input devices 1190 enable user interaction with witness encryption systems and provide mechanisms for entering cryptographic parameters, selecting operational modes, and controlling system behavior. The user input devices 1190 may include keyboards, pointing devices, and other input mechanisms that support secure entry of cryptographic data and system commands. In some cases, the user input devices 1190 may implement security features such as secure key entry and tamper detection to protect against unauthorized access and data compromise. The user input devices 1190 enable users to configure time-lock puzzle parameters, initiate cryptographic operations, and interact with witness encryption systems through intuitive interfaces.

A system bus 1195 provides the primary communication infrastructure for the client computing architecture 1100 and enables data transfer between different subsystems and components. The system bus 1195 coordinates communication between the processing subsystem 1105, memory subsystem 1135, storage subsystem 1150, and client I/O subsystem 1170, ensuring efficient data flow throughout the system. In time-lock puzzle applications, the system bus 1195 may need to support high-bandwidth data transfer to accommodate the substantial computational and data movement requirements associated with puzzle-solving operations. The system bus 1195 may implement security features to protect data during inter-component communication and may include mechanisms for isolating different types of cryptographic operations to prevent interference and maintain system security.

### Network Deployment Architecture

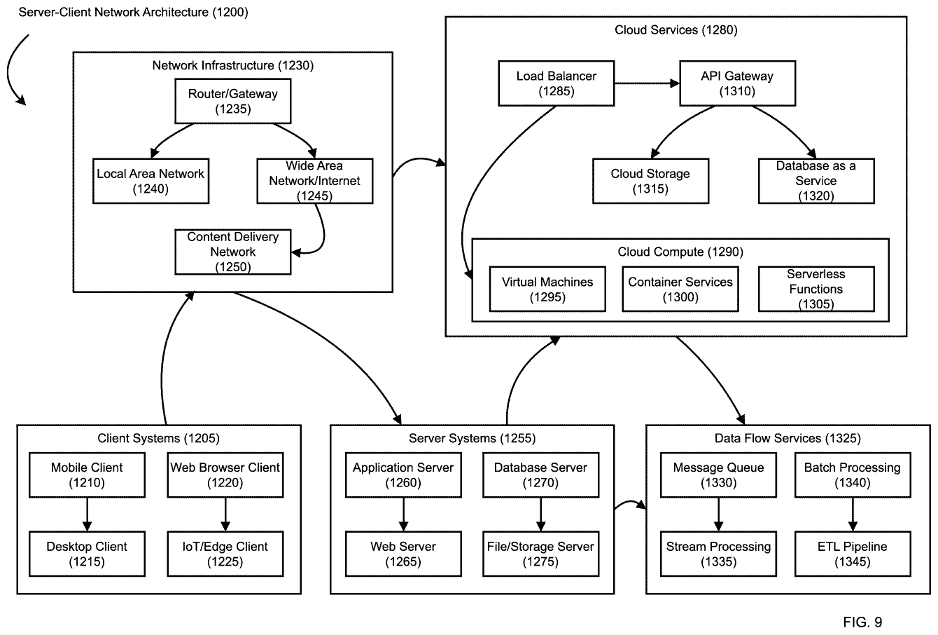

Referring to FIG. 9, a server client network architecture 1200 provides a comprehensive framework for deploying witness encryption schemes across distributed computing environments. The server client network architecture 1200 encompasses multiple interconnected layers that facilitate the implementation of various cryptographic operations, including generating a non-interactive zero-knowledge (NIZK) common reference string NIZK.crs using a cryptographically secure random number generator and creating witness encryption ciphertexts across different network components. The architecture enables scalable deployment of witness encryption implementations while maintaining security properties across diverse computing platforms and service configurations.

Client systems 1205 form the foundational layer of the server client network architecture 1200, encompassing various device types that may initiate cryptographic operations or consume encrypted content. A mobile client 1210 may execute lightweight cryptographic operations such as receiving, via a network interface of the computer system, the message μ and the attribute x from a client device, while maintaining computational efficiency for battery-powered operations. A desktop client 1215 may perform more computationally intensive operations, including generating first and second random values r₀ and r₁ from the set {0, 1}^{λ} using a cryptographically secure random number generator, leveraging greater processing power and memory resources. A web browser client 1220 may implement witness encryption schemes through JavaScript implementations or WebAssembly modules, enabling cross-platform deployment without native application installation. An IoT edge client 1225 may handle specialized cryptographic operations in constrained environments, potentially implementing lightweight versions of witness encryption algorithms optimized for embedded systems.

Network infrastructure 1230 provides the communication backbone that enables distributed cryptographic operations across the server client network architecture 1200. A router gateway 1235 may implement network-level security policies and traffic routing for cryptographic communications, ensuring secure transmission of sensitive cryptographic materials such as master public keys and function keys. A local area network 1240 may facilitate high-speed communication between local cryptographic entities, enabling efficient distribution of computational tasks such as creating a first commitment com₀ by computationally committing a zero value using the commitment scheme common reference string and the first random value r₀. A wide area network 1245 may connect geographically distributed components of witness encryption systems, supporting scenarios where key generation entities and encryption entities operate across different physical locations. A content delivery network 1250 may cache and distribute cryptographic parameters and public keys, reducing latency for witness encryption operations that require access to common reference strings and public cryptographic materials.

Server systems 1255 provide the computational backbone for complex witness encryption operations that exceed the capabilities of client devices. An application server 1260 may implement the core witness encryption algorithms, including creating a witness encryption ciphertext WE.ct by computationally encrypting μ using a witness encryption scheme WE.Enc implemented in software, where the encryption is associated with a relation WE.R that includes computational verification of a NIZK proof π, a condition that ƒ(x)=1, and a condition that a function Trigger(tag_{ƒ}, tagₓ)=0. A web server 1265 may provide HTTP-based interfaces for witness encryption services, enabling client applications to access cryptographic functionality through RESTful APIs or GraphQL endpoints. A database server 1270 may store cryptographic keys, function keys, and encrypted ciphertexts, implementing secure storage mechanisms for sensitive cryptographic materials such as master secret keys and function keys sk_{ƒ}. A storage server 1275 may provide high-capacity storage for large-scale witness encryption deployments, maintaining encrypted data repositories and supporting backup and recovery operations for cryptographic systems.

Cloud services 1280 extend the server client network architecture 1200 with scalable, on-demand computing resources that can dynamically adapt to varying cryptographic workloads. A load balancer 1285 may distribute witness encryption operations across multiple computing instances, ensuring optimal resource utilization and fault tolerance for cryptographic services. The load balancer 1285 may implement intelligent routing algorithms that consider the computational complexity of different witness encryption schemes, directing operations such as a multilinear maps-based construction that utilizes cryptographic multilinear maps to appropriately provisioned computing resources. Cloud compute 1290 provides the foundational computing infrastructure for cloud-based witness encryption deployments, encompassing various virtualization and containerization technologies that enable flexible resource allocation and scaling.

Virtual machines 1295 within the cloud compute 1290 may host complete witness encryption systems, providing isolated execution environments for sensitive cryptographic operations. Each virtual machine may implement different witness encryption schemes, including an indistinguishability obfuscation-based construction that obfuscates a program checking witness validity or a lattice-based construction utilizing the hardness of the Learning With Errors problem. Container services 1300 may provide lightweight, portable deployment units for witness encryption components, enabling rapid scaling and deployment of cryptographic services across different cloud environments. Serverless functions 1305 may implement specific cryptographic operations as event-driven functions, such as generating a dummy input tag tagₓ for the attribute x comprising a somewhere equivocal pseudorandom function key key and a garbled input \tilde{x} derived from x using cryptographic operations.

An API gateway 1310 serves as the central entry point for witness encryption services, providing authentication, authorization, and rate limiting for cryptographic operations. The API gateway 1310 may implement protocol translation between different client types and backend services, enabling seamless integration of witness encryption functionality across diverse client platforms. Cloud storage 1315 may provide scalable, durable storage for encrypted data and cryptographic materials, implementing redundancy and backup mechanisms to ensure data availability and integrity. A database service 1320 may offer managed database solutions optimized for cryptographic applications, providing features such as encryption at rest and in transit, automated backup and recovery, and high availability configurations.

Data flow services 1325 orchestrate the movement and processing of cryptographic data across the server client network architecture 1200, enabling complex witness encryption workflows that span multiple system components. A message queue 1330 may facilitate asynchronous communication between cryptographic components, enabling decoupled architectures where encryption entities can submit cryptographic operations for processing without blocking on completion. The message queue 1330 may implement persistent messaging to ensure reliable delivery of cryptographic operations, even in the presence of system failures or network partitions. Stream processing 1335 may handle real-time cryptographic operations, processing continuous streams of encryption and decryption requests with low latency requirements.

Batch processing 1340 may handle large-scale cryptographic operations that can be processed offline or during periods of low system utilization. The batch processing 1340 may implement optimized algorithms for bulk operations such as generating multiple function keys or processing large volumes of witness encryption operations. An ETL pipeline 1345 may facilitate data transformation and migration operations for cryptographic systems, enabling the conversion of cryptographic data between different formats or the migration of encrypted data between different storage systems. The ETL pipeline 1345 may implement specialized transformations for witness encryption data, such as converting between different witness encryption scheme formats or updating cryptographic parameters during system upgrades.

The server client network architecture 1200 supports various deployment patterns for witness encryption schemes, enabling organizations to select appropriate configurations based on security requirements, performance constraints, and operational considerations. In some cases, the architecture may implement a distributed deployment where key generation occurs on secure server systems 1255, while encryption operations are performed on client systems 1205, and decryption operations utilize cloud services 1280 for scalability. The architecture may also support hybrid deployments where any arbitrary witness encryption scheme that may be interchangeably replaced with another witness encryption scheme can be deployed across different network components based on specific use case requirements.

The network architecture enables sophisticated cryptographic workflows where creating a second commitment com₁ by computationally committing a string of zeros of length l(λ) using the commitment scheme common reference string and the second random value r₁ may occur on server systems 1255, while storing a ciphertext ct that includes x, tagₓ, and WE.ct in a memory of the computer system may be distributed across cloud storage 1315 and database service 1320. The architecture supports transmitting, via the network interface, the ciphertext ct to a recipient device through various network paths, enabling flexible communication patterns that can adapt to different security and performance requirements.

Advanced cryptographic operations such as applying a witness decryption algorithm WE.Dec implemented in software to the witness encryption ciphertext WE.ct using (ƒ, tag_{ƒ}, π) as the witness may be distributed across multiple components of the server client network architecture 1200. The decryption process may involve coordination between serverless functions 1305 for lightweight operations, virtual machines 1295 for computationally intensive tasks, and database service 1320 for secure key retrieval. The architecture enables storing the decrypted message μ in the memory across distributed storage systems, providing redundancy and availability for decrypted content.

The server client network architecture 1200 facilitates the implementation of complex witness encryption schemes that involve multiple cryptographic operations and data flows. Operations such as computing a pseudorandom function on key and t₀ to derive a pad p, performing a bitwise XOR operation of p with t₁ to derive a garbled circuit \tilde{C}, and evaluating garbled circuit \tilde{C} on the garbled input \tilde{x} and outputting 1 if the result matches t₂ may be distributed across different components of the architecture based on computational requirements and security considerations. The architecture provides the flexibility to deploy witness encryption schemes using various underlying cryptographic primitives while maintaining consistent interfaces and operational characteristics across different deployment configurations.

Throughout this disclosure, various terms and phrases are used to describe features of the disclosed technology. It is to be understood that these terms and phrases may encompass a variety of meanings and definitions, as is common in the field of technology and patent law. The definitions of these terms may vary depending on the context in which they are used, the specific embodiment being described, or the interpretation of the technology by those skilled in the art.

In various embodiments, certain variable names, symbols, or labels may be used in the claims to represent various elements, components, or steps of the described methods, systems, and apparatuses. These variable names, symbols, or labels are provided for convenience and clarity in describing the claimed subject matter. However, it should be understood that the use of such variable names, symbols, or labels in the claims does not necessarily limit these elements, components, or steps to being the same specific entities described in the specification or in other parts of the disclosure. The variable names, symbols, or labels used in the claims should be interpreted broadly and may encompass various implementations, variations, or equivalents of the described elements, components, or steps, unless explicitly stated otherwise or clearly limited by the context of the claim. As such, the scope of the claims is not confined to the specific examples or embodiments described in the specification, but rather extends to the full breadth of the inventive concepts disclosed herein.

For instance, terms such as “computing device,” “processor,” “memory,” and “network” may refer to a wide range of devices, components, systems, and configurations known in the art, and their specific definitions may differ based on the implementation or design of the system. Similarly, phrases like “securely storing,” “computing a vector,” and “generating a message” may involve various methods, techniques, and processes that achieve the same or similar outcomes but may be executed in different manners.

It is also to be understood that the use of terms in the singular or plural form is not intended to limit the scope of the claims. For example, the mention of “a computing device” does not preclude the presence of multiple computing devices within a system. Likewise, references to “a network” may include various interconnected networks or a single network comprising multiple segments or layers.

Furthermore, the use of the term “may” in relation to an action or feature indicates that the action or feature is possible, but not necessarily mandatory. This term is used to describe optional or alternative aspects of the disclosed technology that provide flexibility in how the technology may be implemented or utilized.

The definitions provided herein are intended to serve as examples and are not exhaustive. Those skilled in the art may ascribe different meanings to these terms based on the context, the specific technology being described, or the advancements in the field. Therefore, the definitions of the terms and phrases used in this disclosure and the claims are to be interpreted broadly and in a manner consistent with the understanding of those skilled in the relevant art.

The use of the word “a” or “an” when used in conjunction with the claims herein is to be interpreted as including one or more than one of the element it introduces. Similarly, the use of the term “or” is intended to be inclusive, such that the phrase “A or B” is intended to include A, B, or both A and B, unless explicitly stated otherwise.

Reference throughout the specification to “one embodiment,” “another embodiment,” “an embodiment,” and so forth, means that a particular feature, structure, or characteristic described in connection with the embodiment is included in at least one embodiment of the present disclosure, and may not necessarily be present in all embodiments. Furthermore, the particular features, structures, or characteristics may be combined in any suitable manner in one or more embodiments without limitation.

The use of the terms “first,” “second,” and the like does not imply any order or sequence, but are used to distinguish one element from another, and the terms “top,” “bottom,” “front,” “back,” “leading,” “trailing,” and the like are used for descriptive purposes and are not necessarily to be construed as limiting.

As used herein, the term “processor” refers to any computing entity capable of executing instructions to perform a specific set of operations, whether implemented in hardware, firmware, software, or any combination thereof. This definition includes a broad range of processing technologies and architectures. The term encompasses general-purpose processors such as Central Processing Units (CPUs), specialized processors such as Graphics Processing Units (GPUs), as well as highly specialized hardware accelerators such as Neural Processing Units (NPUs) for artificial intelligence applications and Tensor Processing Units (TPUs) for machine learning workloads.

The term also encompasses reconfigurable computing architectures such as Field-Programmable Gate Arrays (FPGAs) for applications requiring specialized processing configurations, Application-Specific Integrated Circuits (ASICs), Digital Signal Processors (DSPs), Systolic Array Processors, and emerging computing paradigms such as Quantum Processors that leverage principles of quantum mechanics. System on Chip (SoC) designs, heterogeneous computing systems, Edge Computing Processors for distributed network applications, cloud-based and distributed processors, multi-core and parallel processors, and Neuromorphic processors that draw inspiration from biological neural architectures are all encompassed within this definition.

The term “processor” also encompasses the associated memory hierarchies, including primary memory (such as RAM), secondary storage (such as hard drives and SSDs), and cache memory, which work in conjunction with the processor to store and retrieve data necessary for executing instructions. In this patent application, any reference to a “processor” should be interpreted broadly to include any type of processing unit capable of performing the described functions, regardless of its specific implementation, architecture, or physical form.

As used herein, the term “messages” may refer to any form of data or information that can be processed, transmitted, or stored in a digital format. Messages may include arbitrary-length plaintext messages, pre-hashed messages, concatenated messages, binary data, network protocol messages, database records, and time-stamped messages. Messages may be composed of characters, symbols, or binary data and may represent various forms of content such as text, numbers, multimedia, executable code, or any other data that can be digitally encoded. Messages may be used as input for cryptographic functions, such as keyed hash functions, where they are transformed into a fixed-size hash value influenced by a secret cryptographic key.

The term “messages” encompasses a wide range of data types and structures, from simple text strings to complex structured data, and may include metadata, headers, footers, or other information that facilitates the processing, transmission, or interpretation of the content. Messages may be generated by users, systems, or processes and may be intended for various purposes, including communication, authentication, verification, logging, or any other function that involves the use of digital data.

Messages may also include data formats specific to artificial intelligence and machine learning applications, such as tensors, feature vectors, embeddings, model parameters, activation maps, training examples, and inference requests. In distributed and edge computing contexts, the term “messages” further extends to include event streams, state updates, service requests, synchronization messages, and smart contract transactions used in blockchain platforms.

As used herein, the terms “store,” “storing,” “storage,” or variants thereof refer to any means, methods, systems, or processes for recording, retaining, or preserving data in a retrievable format. This terminology encompasses a broad spectrum of technologies and mechanisms that may be employed to maintain information for future access or reference.

The term “storing” or “storage” as used in this specification may encompass both persistent and transient data retention. In some cases, the storage may be entirely ephemeral, lasting only for the duration of a specific operation or process. The use of these terms does not imply any particular time period for data retention or any level of permanence. Storage and storing may be as brief as a few microseconds or indefinitely long, depending on the specific implementation and requirements of the system.

The term includes traditional electronic storage technologies such as magnetic storage (including hard disk drives, magnetic tape, and floppy disks), optical storage (including optical discs, holographic storage, and optical tape), and solid-state storage (including solid-state drives, flash memory, static random-access memory, dynamic random-access memory, and read-only memory). It also encompasses emerging storage technologies such as DNA storage, molecular storage, quantum storage, and photonic storage.

Storage terminology may refer to various architectural organizations and hierarchies of data repositories. This includes primary storage (main memory, cache memory) designed for rapid access during processing operations; secondary storage providing nonvolatile retention of larger data volumes; and tertiary storage for archival purposes. The terminology extends to distributed storage architectures such as network-attached storage (NAS), storage area networks (SAN), direct-attached storage (DAS), and object storage systems. It also includes cloud-based storage configurations, including public, private, and hybrid cloud storage implementations; edge storage systems located at network peripheries; and fog storage systems distributed between centralized and edge locations.

The definition encompasses storage virtualization technologies that abstract physical storage resources and present them as logical storage units, including virtual disks, software-defined storage, and storage hypervisors. It also includes storage orchestration systems that manage data placement, replication, and migration across distributed infrastructures.

The terminology extends to various data organization and management paradigms. This includes file systems that organize data into files and directories; block storage systems that manage data as fixed-sized blocks; object storage systems that handle data as discrete objects with metadata; and content-addressable storage systems that retrieve data based on content rather than location. It also includes specialized storage structures such as databases, data lakes, data warehouses, and knowledge repositories.

Storage terminology encompasses various operational characteristics and capabilities of storage systems. This includes persistent storage that maintains data integrity across power cycles; volatile storage that requires continuous power to retain data; and nonvolatile storage that preserves data without power. It also includes immutable storage that prevents modification of stored data; append-only storage that allows additions but not modifications; and version-controlled storage that maintains historical states of data. The term further encompasses encrypted storage that protects data confidentiality; redundant storage that duplicates data to prevent loss; and resilient storage that maintains availability despite component failures.

In specialized computing contexts, storage terminology may refer to domain-specific storage mechanisms. For blockchain and distributed ledger technologies, this includes on-chain storage within the blockchain itself and off-chain storage that maintains references to externally stored data. For neural networks and artificial intelligence systems, it includes weight storage for maintaining learned parameters and activation storage for intermediate computational results. For quantum computing systems, it refers to quantum state storage that preserves quantum information, while for edge computing, it includes transient storage for temporary data processing at network boundaries.

The term “storage” also encompasses the protocols, interfaces, and access methods used to interact with stored data. This includes file access protocols (such as NFS, SMB, and HDFS), block access protocols (such as iSCSI, Fibre Channel, and ATA), and object access protocols (such as S3, Swift, and CDMI). It also includes direct memory access mechanisms, memory-mapped file interfaces, and storage controller interfaces.

The term “database” should be construed to mean a blockchain, distributed ledger technology, key-value store, document-oriented database, graph database, time-series database, in-memory database, columnar database, object-oriented database, hierarchical database, network database, or any other structured data storage system capable of storing and retrieving information. This may include traditional relational database management systems (RDBMS), NoSQL databases, NewSQL databases, or hybrid database systems that combine multiple database paradigms. The database may be centralized, distributed, or decentralized, and may employ various data models, indexing strategies, and query languages to organize and access the stored information. It may also incorporate features such as ACID (Atomicity, Consistency, Isolation, Durability) compliance, eventual consistency, sharding, replication, or partitioning to ensure data integrity, availability, and scalability. The database may be hosted on-premises, in the cloud, or in a hybrid environment, and may support various access methods including direct queries, API calls, or event-driven architectures.

The term “database” further encompasses specialized data storage and management systems designed for particular domains or use cases. This includes blockchain and distributed ledger technologies used for secure, decentralized transaction records, edge databases optimized for resource-constrained environments, vector databases for high-dimensional data, time-series databases for temporal data management, knowledge graphs for representing interconnected information, federated databases for integrating autonomous systems, and emerging paradigms such as quantum databases that leverage quantum computing principles.

The terms “connected,” “coupled,” or any variant thereof, mean any direct or indirect connection or coupling between two or more elements, and may encompass the presence of one or more intermediate elements between the two elements that are connected or coupled to each other.

In the context of modern computing architectures and network topologies, these terms may also refer to various connection modalities. This includes physical connections through wired or wireless interfaces, logical connections operating independently of the physical layer, API connections allowing software components to communicate, and microservice connections in distributed architectures. The terminology extends to edge-to-cloud connections for distributed processing environments, blockchain connections for distributed ledger systems, quantum connections for secure communication, and neural network connections for artificial intelligence systems.

As used herein, the term “display” or “displaying” refers to any means, method, apparatus, or process for visually presenting or otherwise conveying information to a user. This terminology encompasses a broad spectrum of technologies and presentation modalities that may be employed to render content perceivable by a user. The term includes traditional display technologies such as cathode ray tubes (CRTs), liquid crystal displays (LCDs), light-emitting diode (LED) displays, organic light-emitting diode (OLED) displays, micro-LED displays, and electronic paper displays. It also encompasses specialized display types such as transparent displays, flexible displays, foldable displays, stretchable displays, and holographic displays.

The term “display” may also refer to projection systems, including traditional projectors, laser projectors, pico projectors, and holographic projection systems. It further includes immersive display technologies such as head-mounted displays (HMDs), virtual reality (VR) headsets, augmented reality (AR) glasses, mixed reality (MR) systems, and smart contact lenses. The terminology extends to ambient display methods that integrate visual information into the environment, such as smart mirrors, interactive surfaces, projection mapping systems, and volumetric displays.

The definition also encompasses non-visual display modalities that may complement or substitute for visual displays. This includes auditory displays such as speech output systems, sonification interfaces, and spatial audio; haptic displays that communicate through tactile feedback, vibration patterns, or force feedback; and other sensory output mechanisms such as olfactory displays and thermotactile interfaces. Multimodal displays that combine multiple sensory channels for information presentation are also included within this terminology.

The term “display” further encompasses the software and computational components involved in rendering information. This includes rendering engines, graphics processing pipelines, display servers, and compositing systems. It also includes specialized display rendering techniques such as rasterization, ray tracing, vector graphics, procedural generation, and neural rendering. The term extends to user interface paradigms such as graphical user interfaces (GUIs), natural user interfaces (NUIs), voice user interfaces (VUIs), brain-computer interfaces (BCIs), and ambient intelligence systems.

In the context of accessibility, the term “display” includes assistive technologies and alternative display methods designed to accommodate diverse user needs. This encompasses screen readers, braille displays, audio descriptions, high-contrast modes, color-shifted presentations, and other adaptive display mechanisms. The terminology also includes display personalization techniques such as adaptive interfaces, contextual displays, and user-specific rendering optimizations.

The description of the embodiments of the present disclosure is intended to be illustrative, and not to limit the scope of the claims. Many alternatives, modifications, and variations will be apparent to those skilled in the art. A number of implementations have been described. Nevertheless, it will be understood that various modifications may be made without departing from the spirit and scope of the disclosure. Accordingly, other implementations are within the scope of the following claims.

1. A method for implementing an attribute-based encryption (ABE) scheme, comprising:
encrypting, by one or more processors of a computing device, a message μ for an attribute x by:
i) generating a dummy input tag tagₓ for the attribute x comprising a somewhere equivocal pseudorandom function key key and a garbled input i derived from x using cryptographic operations;
ii) creating a witness encryption ciphertext WE.ct by computationally encrypting μ using a witness encryption scheme WE.Enc implemented in software stored in a computer memory of the computing device, where the encryption is associated with a relation WE.R that includes:
(a) computational verification of a NIZK proof π;
(b) a condition that ƒ(x)=1;
(c) a condition that a function Trigger(tag_{ƒ}, tagₓ)=0, wherein the Trigger function comprises:
i. computing a pseudorandom function on key and to t₀ derive a pad p;
ii. performing a bitwise XOR operation of p with t₁ to derive a garbled circuit \tilde{C};
iii. evaluating garbled circuit \tilde{C} on the garbled input \tilde{x} and outputting 1 if the result matches t₂; and
iii) storing a ciphertext ct that includes x, tagₓ, and WE.ct in the computer memory of the computing device.

2. The method of claim 1, further comprising generating, by the one or more processors, a master public key and a master secret key by:
i) generating a non-interactive zero-knowledge (NIZK) common reference string NIZK.crs using a cryptographically secure random number generator;
ii) generating a commitment scheme common reference string Com.crs using a cryptographically secure random number generator;
iii) generating first and second random values r₀ and r₁ from the set {0, 1}^{λ} using a cryptographically secure random number generator;
iv) creating a first commitment com₀ by computationally committing a zero value using the commitment scheme common reference string and the first random value r₀;
v) creating a second commitment com₁ by computationally committing a string of zeros of length [symbol] (λ) using fie commitment scheme common reference string and the second random value r₁;
vi) setting, in the computer memory, the master public key mpk to include Com.crs, NIZK.crs, com₀, and com₁;
vii) setting, in the computer memory, the master secret key msk to be r₀.

3. The method of claim 2, further comprising generating, by the one or more processors, a function key sk_{ƒ} for a function ƒ by:
i) generating a dummy function tag tag_{ƒ} for the function ƒ using a function tag system implemented in software, wherein the dummy function tag tag_{ƒ} comprises three random values t₀, t₁, t₂ from the set {0, 1}^{λ} generated using a cryptographically secure random number generator;
ii) creating the NIZK proof π using NIZK.crs, where the proof is computationally associated with an NP relation NIZK.R that includes a statement \tilde{x}=(Com.crs, com₀, com₁, ƒ, tag_{ƒ}) and a witness \tilde{w}=r₀; and
iii) storing the function key sk_{ƒ} as (ƒ, tag_{ƒ}, π) in the computer memory.

4. The method of claim 1, further comprising decrypting, by the one or more processors, the ciphertext ct using a function key sk_{ƒ} by:
i) applying a witness decryption algorithm WE.Dec implemented in software to the witness encryption ciphertext WE.ct using (ƒ, tag_{ƒ}, π) as the witness; and
ii) storing the decrypted message μ in the computer memory.

5. The method of claim 1, wherein the functional tag system is configured for generating tagₓ←DInputTag(1^{λ}, x), tag_{ƒ}←DFunctionTag(1^{λ}, ƒ).

6. The method of claim 1, wherein the garbled circuit is a semi-adaptive blind circuit.

7. The method of claim 6, wherein the semi-adaptive blind garbled circuit scheme further comprises an evaluation function Eva(\tilde{C}, \tilde{x}) that outputs the result of evaluating the garbled circuit \tilde{C} on the garbled input \tilde{x}.

8. The method of claim 1, wherein the functional tag system includes a trigger function Trigger(tag_{ƒ}, tagₓ) that outputs either 0 or 1 based on the input tag tagₓ and function tag tag_{ƒ}.

9. The method of claim 7, wherein the semi-adaptive blind garbled circuit scheme satisfies a blindness property such that for any fixed garbling secret key sk and input x, the distribution of SimCircuit(sk, x, Uₘ) is identical to the uniform distribution over {0, 1} [symbol] , where SimCircuit is a simulated circuit generation function, Uₘ denotes the uniform distribution over m-bit strings, and [symbol] is the garbled circuit size.

10. The method of claim 1, wherein the method achieves adaptive security for attribute-based encryption by utilizing the functional tag system in conjunction with the semi-adaptive blind garbled circuit scheme.

11. A system for implementing an attribute-based encryption (ABE) scheme, comprising: one or more processors; a network interface; and a memory storing instructions that, when executed by the one or more processors, cause the system to perform operations comprising:
encrypting a message μ for an attribute x by:
i) receiving, via the network interface, the message μ and the attribute x from a client device;
ii) generating a dummy input tag tagₓ for the attribute x comprising a somewhere equivocal pseudorandom function key key and a garbled input i derived from x using cryptographic operations;
iii) creating a witness encryption ciphertext WE.ct by computationally encrypting μ using a witness encryption scheme WE.Enc implemented in software, where the encryption is associated with a relation WE.R that includes:
(a) computational verification of a NIZK proof π;
(b) a condition that ƒ(x)=1;
(c) a condition that a function Trigger(tag_{ƒ}, tagₓ)=0, wherein the Trigger function comprises:
i. computing a pseudorandom function on key and to t₀ derive a pad p;
ii. performing a bitwise XOR operation of p with t₁ to derive a garbled circuit \tilde{C};
iii. evaluating garbled circuit \tilde{C} on the garbled input \tilde{x} and outputting 1 if the result matches t₂; and
iv) storing a ciphertext ct that includes x, tagₓ, and WE.ct in the memory.

12. The system of claim 11, wherein the operations further comprise generating a master public key and a master secret key by:
i) generating a non-interactive zero-knowledge (NIZK) common reference string NIZK.crs using a cryptographically secure random number generator;
ii) generating a commitment scheme common reference string Com.crs using a cryptographically secure random number generator;
iii) generating first and second random values r₀ and r₁ from the set {0, 1}^{λ} using a cryptographically secure random number generator;
iv) creating a first commitment com₀ by computationally committing a zero value using the commitment scheme common reference string and the first random value r₀;
v) creating a second commitment com₁ by computationally committing a string of zeros of length [symbol] (λ) using the commitment scheme common reference string and the second random value r₁;
vi) setting, in the memory, the master public key mpk to include Com.crs, NIZK.crs, com₀, and com₁;
vii) setting, in the memory, the master secret key msk to be r₀.

13. The system of claim 12, wherein the operations further comprise generating a function key sk_{ƒ} for a function ƒ by:
i) generating a dummy function tag tag_{ƒ} for the function ƒ using a function tag system implemented in software, wherein the dummy function tag tag_{ƒ} comprises three random values t₀, t₁, t₂ from the set {0, 1}^{λ} generated using a cryptographically secure random number generator;
ii) creating the NIZK proof π using NIZK.crs, where the proof is computationally associated with an NP relation NIZK.R that includes a statement \tilde{x}=(Com.crs, com₀, com₁, ƒ, tag_{ƒ}) and a witness \tilde{w}=r₀; and
iii) storing the function key sk_{ƒ} as (ƒ, tag_{ƒ}, π) in the memory.

14. The system of claim 11, wherein the operations further comprise decrypting the ciphertext ct using a function key sk_{ƒ} by:
i) applying a witness decryption algorithm WE.Dec implemented in software to the witness encryption ciphertext WE.ct using (ƒ, tag_{ƒ}, π) as the witness; and
ii) storing the decrypted message μ in the memory.

15. A non-transitory computer-readable storage medium storing instructions that, when executed by one or more processors of a computer system, cause the computer system to perform operations comprising:
encrypting a message μ for an attribute x by:
i) receiving, via a network interface of the computer system, the message μ and the attribute x from a client device;
ii) generating a dummy input tag tagₓ for the attribute x comprising a somewhere equivocal pseudorandom function key key and a garbled input \tilde{x} derived from x using cryptographic operations;
iii) creating a witness encryption ciphertext WE.ct by computationally encrypting μ using a witness encryption scheme WE.Enc implemented in software, where the encryption is associated with a relation WE.R that includes:
(a) computational verification of a NIZK proof π;
(b) a condition that ƒ(x)=1;
(c) a condition that a function Trigger(tag_{ƒ}, tagₓ)=0, wherein the Trigger function comprises:
i. computing a pseudorandom function on key and to t₀ derive a pad p;
ii. performing a bitwise XOR operation of p with t₁ to derive a garbled circuit \tilde{C};
iii. evaluating garbled circuit \tilde{C} on the garbled input \tilde{x} and outputting 1 if the result matches t₂; and
iv) storing a ciphertext ct that includes x, tagₓ, and WE.ct in a memory of the computer system;
v) transmitting, via the network interface, the ciphertext ct to a recipient device.

16. The non-transitory computer-readable storage medium of claim 15, wherein the operations further comprise generating a master public key and a master secret key by:
i) generating a non-interactive zero-knowledge (NIZK) common reference string NIZK.crs using a cryptographically secure random number generator;
ii) generating a commitment scheme common reference string Com.crs using a cryptographically secure random number generator;
iii) generating first and second random values r₀ and r₁ from the set {0, 1}^{λ} using a cryptographically secure random number generator;
iv) creating a first commitment com₀ by computationally committing a zero value using the commitment scheme common reference string and the first random value r₀;
v) creating a second commitment com₁ by computationally committing a string of zeros of length [symbol] (λ) using the commitment scheme common reference string and the second random value r₁;
vi) setting, in the memory, the master public key mpk to include Com.crs, NIZK.crs, com₀, and com₁;
vii) setting, in the memory, the master secret key msk to be r₀.

17. The non-transitory computer-readable storage medium of claim 16, wherein the operations further comprise generating a function key sk_{ƒ} for a function ƒ by:
i) generating a dummy function tag tag_{ƒ} for the function ƒ using a function tag system implemented in software, wherein the dummy function tag tag_{ƒ} comprises three random values t₀, t₁, t₂ from the set {0, 1}^{λ} generated using a cryptographically secure random number generator;
ii) creating the NIZK proof π using NIZK.crs, where the proof is computationally associated with an NP relation NIZK.R that includes a statement \tilde{x}=(Com.crs, com₀, com₁, ƒ, tag_{ƒ}) and a witness \tilde{w}=r₀; and
iii) storing the function key sk_{ƒ} as (ƒ, tag_{ƒ}, π) in the memory.

18. The non-transitory computer-readable storage medium of claim 15, wherein the operations further comprise decrypting the ciphertext ct using a function key sk_{ƒ} by:
i) applying a witness decryption algorithm WE.Dec implemented in software to the witness encryption ciphertext WE.ct using (ƒ, tag_{ƒ}, π) as the witness; and
ii) storing the decrypted message μ in the memory.

19. The method of claim 1, wherein the method is performed by distinct entities in communication with each other, comprising:
i) a key generation entity that generates the master public key and master secret key and transmits the master public key to other entities;
ii) a function key generation entity that receives the master public key and generates function keys; and
iii) an encryption entity that receives the master public key and performs the encryption operations.

20. The method of claim 1, wherein the witness encryption scheme WE.Enc is selected from the group consisting of:
i) a multilinear maps-based construction that utilizes cryptographic multilinear maps;
ii) an indistinguishability obfuscation-based construction that obfuscates a program checking witness validity;
iii) a lattice-based construction utilizing the hardness of the Learning With Errors problem; and
iv) any arbitrary witness encryption scheme that may be interchangeably replaced with another witness encryption scheme.
